(19) United States
(12) Patent Application Publication
(10) Pub. No.: US 2016/0005054 A1
(43) Pub. Date: Jan. 7, 2016

(54) DECISION SUPPORT SYSTEM, METHOD AND COMPUTER PROGRAM PRODUCT

(71) Applicant: Umm Al-Qura University, Makkah (SA)

(72) Inventors: Nabeel KOSHAK, Makkah (SA); Mohammad K. IBRAHIM, Makkah (SA)

(73) Assignee: Umm Al-Qura University, Makkah (SA)

(21) Appl. No.: 14/791,027

(22) Filed: Jul. 2, 2015

Related U.S. Application Data
(60) Provisional application No. 62/020,646, filed on Jul. 3, 2014.

(51) Int. Cl. G06Q 30/02

(52) U.S. Cl. CPC G06Q 30/0201

(57) ABSTRACT

A system, method, and computer program product are described that implement an analysis system that provides a quantitative basis for redirecting research projects, marketing efforts, and innovation initiatives. A computer implemented decision tool and method is described with a graphics user interface that provides a visual dashboard of fused research/innovation/market activities for observing imbalance in professional activities. The system provides graphical analysis to recommend management oversight adjustments of funding initiatives to provide a greatest return on investment.

### CROSS REFERENCE TO RELATED APPLICATION

The present application contains the benefit of the earlier filing date of U.S. Provisional patent application filed Jul. 3, 2014, entitled “Decision Support System, Method and Computer Program Product”, having common inventorship, attorney docket number 429304US8PROV, the entire contents of which being incorporated herein by reference.

### BACKGROUND

1. Technical Field

The present description relates to systems, methods, and computer program product that provides automatic recommendations that assist a decision maker in assessing and possibly redirecting research projects, and innovation efforts based on market-based efforts in order to maximize the commercialization potential for the products of the research projects and innovation efforts.

2. Description of the Related Art

The “background” description provided herein is for the purpose of generally presenting the context of the disclosure. Work of the presently-named inventors, to the extent it is described in this background section, as well as aspects of the description which may not otherwise qualify as prior art at the time of filing, are neither expressly nor impliedly admitted as prior art against the present invention.

Innovation is a key element in the promotion of a “knowledge economy” and is a primary driver for the development of new products, services and processes, which underlie an economy that is based on ideas, and not necessarily the harvesting of natural resources.

Research commercialization is normally seen as a linear, sequential process however successful commercialization involves interaction between the research, innovations and commercial/market functions and sectors. Moreover, in this conventional process first research is performed, and then an inquiry is made regarding whether the research gave rise to any innovations that could possibly be protected by intellectual property (IP) such as patents. Then, in a subsequent sequential step, once the IP is secured, an inquiry is made regarding whether the IP might be relevant to other activity in the market place that could be an opportunity to commercialize the IP (which owes its origin to the earlier research) in the form of licensing, or formation of a company.

Linear models (sometimes referred to also as a ‘process models’) are generally recognized as a sequential process, and linear models amount to ‘check lists’ (in different forms) of specific tasks to be completed, and technical, market and business conditions to be satisfied or goals to be met on the commercialization path.

### BRIEF SUMMARY OF THE DISCLOSURE

The present inventors recognized that to improve the likelihood that any particular research project will have a reasonable likelihood of spawning commercially valuable products and services, that the research cannot be viewed in isolation of innovation and market relevance. Instead, market information should be a factor in guiding research, and innovation management should also be influenced by market information and research activities. In light of these observations, the present disclosure, according to one aspect, describes an analysis system that provides a quantitative basis for redirecting research projects, marketing efforts, and innovation initiatives.

According to another aspect a computer implemented decision tool is descried with a graphics user interface that provides a visual dashboard of fused research/innovation/market activities for observing imbalance in professional activities.

According to another aspect, a computer-implemented decision support method of providing proposed guidance for innovation management is described.

According to another aspect, a computer-implemented research/innovation optimization method is described that uses graphical analysis to recommend management oversight adjustments of funding initiatives to provide a greatest return on investment.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is an overview graphic of R-I-M correspondence space;

FIG. 1B is a graphic of a R-I correspondence space;

FIG. 1C is a graphic of a I-M correspondence space;

FIG. 1D is a graphic of a R-M correspondence space;

FIG. 1E is a graphic of a R-I-M correspondence space with a triple overlap correspondence region;

FIG. 1F is a flowchart of an exemplary overview process of how the DSS may be interrogated, and after processing the input information, producing an output that may be used by researchers, innovators, business leaders, and/or project managers to guide their activities within their respective spaces;

FIG. 1G is a block diagram of a decision support system according to the present disclosure;

FIG. 2 is a block diagram of a decision support apparatus processor;

FIG. 3 is a data structure of a “research vector”;

FIG. 4 is a data structure of a “market vector”;

FIG. 5 is a data structure of an “innovation vector”;

FIG. 6 is a graph of a project-vector in R-I-M space;

FIG. 7 is diagram of a component vector correlation process to identify overlap regions between pairs of component vectors;

FIG. 8 is diagram of a component vector correlation process to identify overlap regions between three vectors, R, I and M;

FIG. 9 is a flowchart showing how to determine overlap areas for a project vector in R-I-M correspondence space;

FIG. 10 is a block diagram of the vector imbalance processor;

FIG. 11 is a block diagram of a radial length generator;

FIG. 12 is a flowchart showing an amount of imbalance for the project-vector as compared to predetermined thresholds;

FIG. 13 is a block diagram of a vector magnitude analysis performed on the project-vector in R-I-M space;

FIG. 14 is a block diagram of a vector database;

FIGS. 15A-15B are block diagrams of a spider graph generator and correspondence diagram generator;

FIG. 16 is a flowchart showing how to generate spider graphs in the R-I-M space;

FIG. 17 is a block diagram of a static imbalance processor;

FIG. 18 is a flowchart of a process for identifying overlaps of the project in the R-I-M dimensions and identifying imbalance factors relative to predetermined tolerances;

FIG. 19 is a block diagram of a temporal imbalance processor;

FIG. 20 is a flowchart describing how a temporal imbalance analysis is performed;

FIG. 21 is a block diagram of a project feedback processor;

FIG. 22 is a flowchart of a project compliance process performed by the project feedback processor;

FIG. 23 is a block diagram of a commercialization scorecard processor;

FIG. 24 is a block diagram of a commercialization scorecard process and score algorithm, including regional selection;

FIG. 25 is a block diagram of an intellectual property (IP) review processor;

FIG. 26 is a block diagram of an intellectual property analysis process to characterize the project-vector in the IP space;

FIG. 27 is a block diagram of a commercialization scorer mechanism;

FIG. 28 is a flowchart of a commercialization comparison process that compares a combination of IP value and commercialization scorecard values to identify a resultant commercialization score;

FIG. 29 is an exemplary graphical user interface according to the present embodiment;

FIG. 30A is an exemplary correspondence analysis for a particular project in the R-I-M space having a large R-I-M overlap region

FIG. 30B is another correspondence analysis having a smaller R-I-M overlap space with skewed convergence shape;

FIG. 30C is another correspondence analysis having a small R-I-M overlap space with different skewed convergence shape;

FIG. 30D is another correspondence analysis having a small R-I-M overlap space with another different skewed convergence shape;

FIG. 31A is a correspondence analysis graph for another embodiment;

FIG. 31B is a correspondence analysis graph for still another embodiment;

FIG. 31C is a correspondence analysis graph of an embodiment that includes transition from public to the private sector for an immature ecosystem;

FIG. 31D is a correspondence analysis graph for a mature ecosystem;

FIG. 31E is a correspondence analysis graph for conventional macro, meso and micro levels;

FIG. 31F is a correspondence analysis graph for non-concentric macro, meso and micro levels according to an embodiment;

FIG. 32 is a market assessment analysis flowchart performed by a market engine to identify a resultant market value in the market space;

FIG. 33 is a flowchart of a research analysis performed by the research gathering engine to produce a research scorecard and score; and

FIG. 34 is a block diagram of circuitry that implements any of the processors or computer-resources described herein when programmed to perform the algorithms described herein.

### DETAILED DESCRIPTION

Referring now to the drawings, wherein like reference numerals designate identical or corresponding parts throughout the several views, the following description relates to an apparatus and associated methodology for implementing a decision support system. Further, as used herein, the words “a”, “an”, and the like generally carry a meaning of “one or more”, unless stated otherwise. The drawings are generally drawn to scale unless specified otherwise or illustrating schematic structures or flowcharts.

As recognized by the present inventors, research from universities and other public research entities have had some commercial success, some experiencing more than others. The main requirements of taking research from a concept to market are firstly a good knowledge of the market in terms of what products or services resulting from the research are needed in the market place and would be commercially viable. Secondly the right commercial team to implement the transformation of the research to market ready products or services and thirdly and most importantly the financial resources to carry out the commercialization i.e. involvement of the private sector.

Research commercialization and increased innovation are based on effective partnerships between the public and private sector and these partnerships provide synergies which lead to sustainable innovation. Research and innovation in the main comes from the public sector and market intelligence, market needs and financial resource from the private sector.

The present inventors identified that most organizations consider research, innovation and market needs to be largely independent, and carried out in isolation. Generally this leads to reduced and unsustainable innovation, poor partnership between the private and public sector, which is a key requirement for a successful knowledge economy. Moreover, the present inventors recognized that by not providing market data nor research input into the innovation process, without guidance or metrics, can result in innovation efforts that are misguided and have a low likelihood of being commercially significant. Likewise, research, while in some contexts, should be performed independent of commercial application, such as in the case of core fundamental research, cannot be performed in complete isolation if there needs to be a positive economic impact with a great likelihood for a knowledge economy. Moreover, the research itself to some extent should be guided to avoid imbalances between research innovation and market activities.

In light of the foregoing, the present inventors recognized that there is a need for a decision support system for research and innovation facilities, where the decision support system is based on an integrated symbiotic relationship between the commercial marketplace, research, and innovation generation. Moreover, the present inventors recognized that by striking a reasonable balance based on proven correspondence between activities in the research innovation and marketing forums results in high quality innovations and IP, transformation of ideas without IP into ones that do include IP, greater emphasis on research areas that have a market need, and enhancing the relevant skills of researchers in the marketplace.

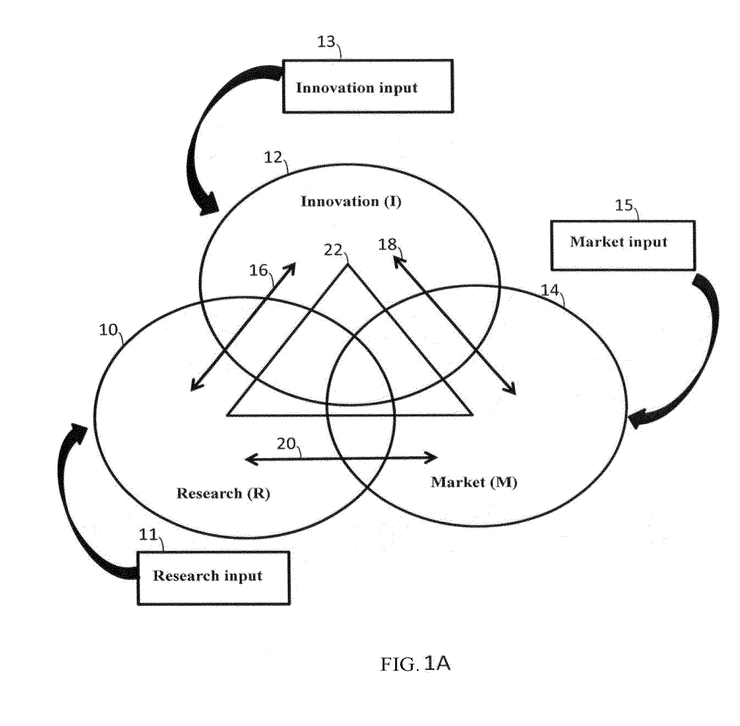

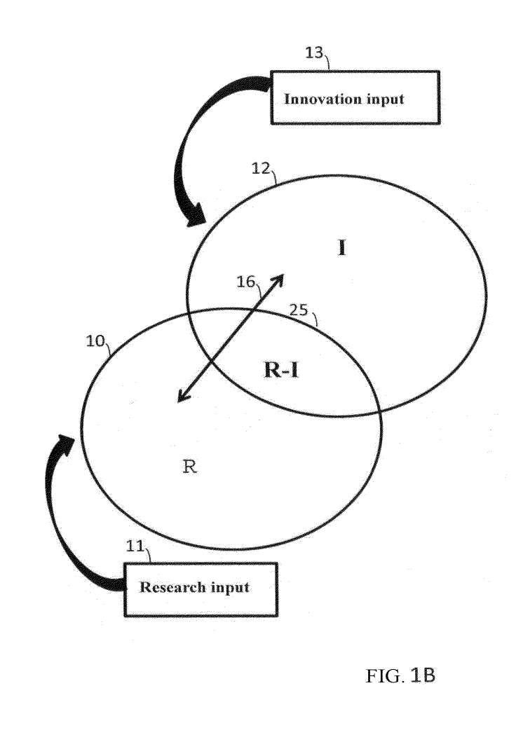

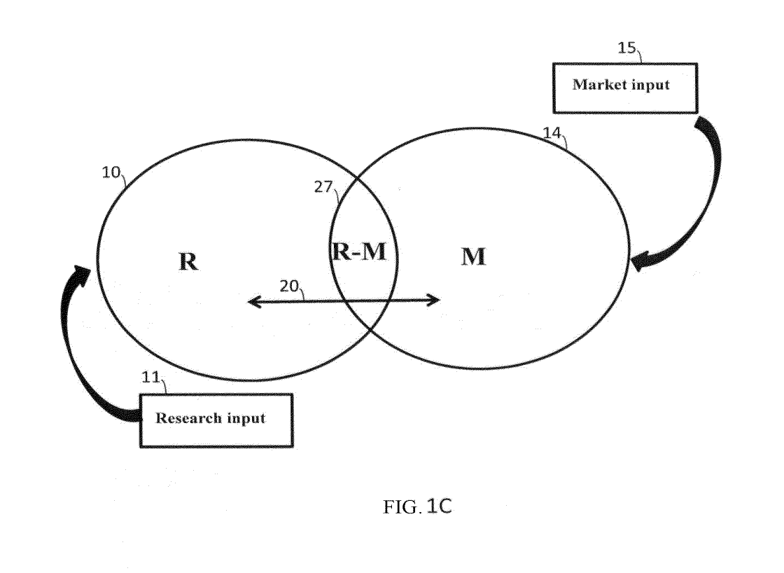

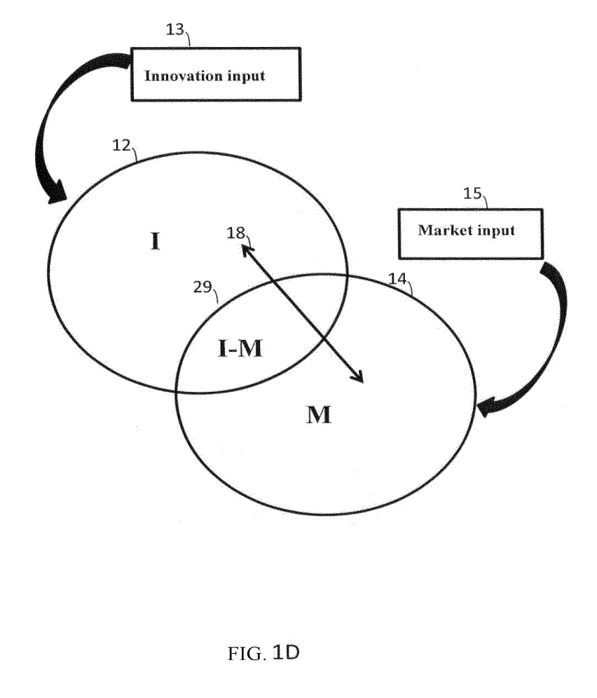

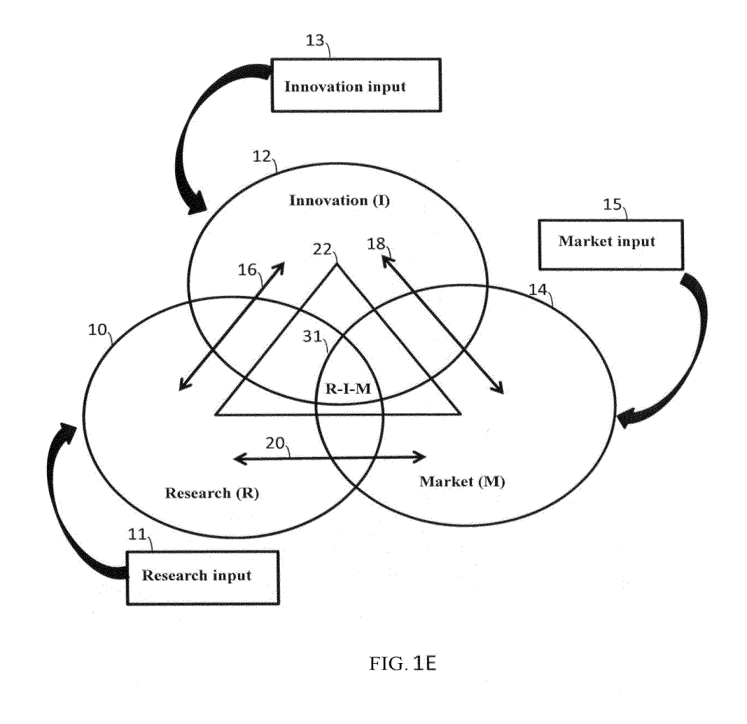

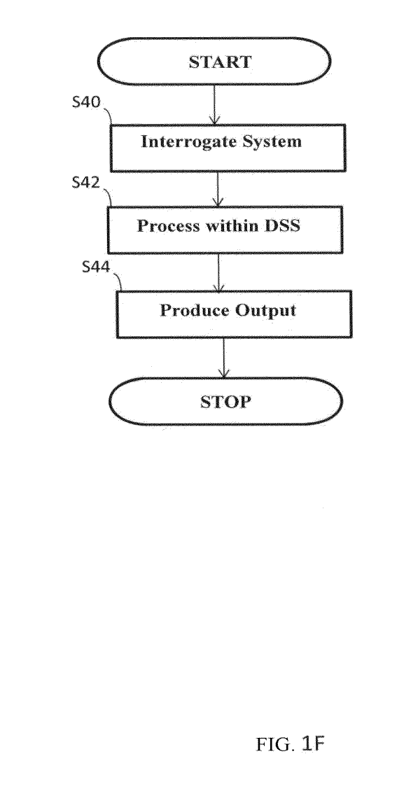

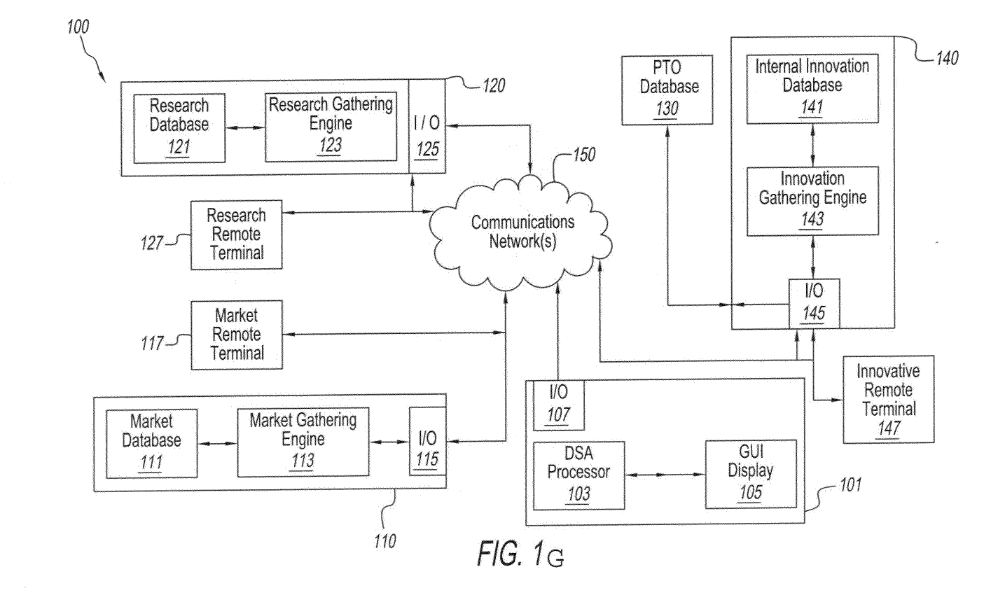

FIG. 1A is an overview graphic of R-I-M correspondence space and is used to illustrate a different approach to viewing and managing correspondence between research (R), innovation (I), and Market (M). This R-I-M correspondence space is an alternative to a conventional linear approach to research and innovation in that is shows an amount of overlap between activities, and illustrates the bilateral nature of interactions of R, I and M when performed in a collaborative way. Moreover, the R-I-M correspondence space is a graphical tool that assists in project management to identify and correct imbalances in research and innovation with respect to available market information.

In FIG. 1A research for a project (also a group of projects, but described herein in the singular for simplicity sake) is represented in a Venn diagram context as Research space 10. Likewise Innovation space 12 and Market space 14 are similarly illustrated. Research space 10, Innovation space 12 and Market space 14 are respectively supplied with research input 11, innovation input 13 and market input 15 respectively. How these spaces and inputs are developed are described later herein. However, for the meantime, the features of FIG. 1A are described to show the overlap and correspondence between Research space 10 and Innovation space 12 for example by way of a bi-directional interaction 16 (as opposed to a serial, consequential interaction in conventional research processes). Likewise there is a bi-directional interaction 18 between the Innovation space 12 and the Market space 14, as shown, and another bidirectional interaction 20 between the Research space 10 and Market space 14. The shape 22 (shown as a triangle in this figure because there is a good balance between respective spaces) is a graphical mechanism for highlighting imbalances between the respective spaces, as will be discussed.

This graphical interface underlies one aspect of the DSS, namely to provide a graphical reporting of a quantitative analysis result that highlights for a project manager whether research and innovation projects are positioned to more closely optimize innovation that will be well received in the market. Aspects of the this optimization process includes (1) increased IP quality, especially patents; (2) awareness for academia on research areas of greatest commercial potential; (3) transform entrepreneurial ideas lacking IP into ones supported by strong IP; (4) define technology sectors of commercial potential; and (5) define the required resources and synergies for sustainable innovation.

One premise of this approach is the realization by the inventors that the commercialization process is not a linear process and should be viewed from three key perspectives which interact in a symbiotic manner. These three perspectives include research (R), innovation (I), and market (M) (collectively R-I-M space) and the interdependency on one other.

Generally research (1st perspective) is one approach toward generating innovation (2nd perspective), which if potentially commercially valuable, should be protected by IP. In order to carry out research that has commercial/market potential, the research should be market led (3rd perspective) in the majority of cases. However investigative research should not be ignored as innovation is sometimes based on serendipity. Likewise, research need not be the only path toward innovation. Another path, for example, is invention management, which is guided by business principals and objectives that first identify the target IP that is desired to be obtained, and then using that vision as a feedback mechanism to the research and development processes. Ideally, to optimize commercialization potential for research and innovation efforts, all three spaces should be seamlessly linked. The DSS, as described herein addresses the 3 perspectives in a bidirectional, proactive and iterative manner.

To further explain the use of R-I-M collaboration space as a guidance tool, FIGS. 1B, 1C, 1D and 1E are presented to illustrate the bidirectional interaction between the three spaces.

FIG. 1B is a subset of the R-I-M collaboration space of FIG. 1A, and illustrates how the interaction between R and I efforts results in a R-I overlap region 25. As can be seen through the bi-directional interaction between R and I, there is a convergence of R and I to produce the overlap region 25. From a management or business oversight perspective, this results in increased knowledge and information by a factor of 2 because of the corresponding overlap contribution from both the R and I domains.

FIG. 1C is a subset of the R-I-M collaboration space of FIG. 1A, and illustrates how the interaction between R and M results in a R-M overlap region 27. As can be seen through the bi-directional interaction between R and M, there is a convergence of R and M to produce the overlap region 27. From a management or business oversight perspective, this results in increased knowledge and information by a factor of 2 because of the corresponding overlap contribution from both the R and M domains.

FIG. 1D is a subset of the R-I-M collaboration space of FIG. 1A, and illustrates how the interaction between I and M efforts results in an I-M overlap region 29. As can be seen through the bi-directional interaction between I and M, there is a convergence of I and M to produce the overlap region 29. From a management or business oversight perspective, this results in increased knowledge and information by a factor of 2 because of the corresponding overlap contribution from both the I and M domains.

FIG. 1E is the same as FIG. 1A, but FIG. 1E identifies the overlap R-I-M overlap region 31, which results in increased knowledge and information by a factor of 7 because of the respective overlaps between R-I, I-M, and M-R, as well as the triple overlap convergence region R-I-M 31. This triple overlap region R-I-M 31 is the culmination of the three separate bi-directional interactions between the R 10, I 12, and M 14 collaboration spaces and is an objective for optimizing research and innovation programs that have a highest potential for commercialization. As will be seen, the graphic representation of the R-I-M space allows for an intuitive understanding of the balance/imbalance of these three activities so that awareness of these imbalances will allow for useful feedback into the research and innovation activities, as well as perhaps redefining a market based on projected new products and services that will reshape future markets. The shape of the correspondence graph of FIG. 1E is stored in memory so it can be used as a standard by which other correspondence graphs for other projects may be compared for imbalances.

FIG. 1F is a flowchart of an exemplary overview process of how the DSS may be interrogated, and after processing the input information, producing an output that may be used by researchers, innovators, business leaders, and/or project managers to guide their activities within their respective spaces. The process begins in step S40 where various queries are applied to the DSS. Example queries include the following: (a) What is the likelihood of obtaining a patent with immediate commercial potential?; (b) Are present research areas of current relevance, and has the research already been done and protected?; (c) Are there research areas in which the institution have strengths and should consolidate?; (d) Are there research areas that the faculty administrators should focus on?; (e) For which application areas are particular technology/invention typically used?; (f) What are the overall trends in patenting in a particular sector over time, territory and application areas?; (g) Which fields are being exploited by which organizations?; (h) How does the institution's invention disclosure compare with current patents and applications?; (i) Where does the institution's patent portfolio sit in the overall landscape—does it form a distinct well-protected area, or is it a single patent surrounded by a thicket of competitors?; (j) Which existing patents may be relevant for freedom to operate and for patentability? i.e. has a freedom to operate been obtained; (k) Where are the whitespace gaps and opportunities to direct our research activities?

The process then proceeds to step S42, where the DSS performs processing (as will be discussed herein) to produce an output in Step S44. The output may be a graphical representation of correspondence between the research or innovation projects and how they compare with the standard model of FIG. 1E. Other example output results include: new IP with commercial potential; commercially active research areas; new emerging research area; IP supported entrepreneurial ideas; and increased research and/or entrepreneurial skills.

FIG. 1G is a block diagram of a decision support system (DSS) 100. The DSS 100 includes a decision support apparatus 101, market support apparatus 110, research support apparatus 120, and innovation support apparatus 140. A communication network(s) 150 interconnects these different components. The communications network 150 may be a private network, a public network (e.g., the Internet) or a hybrid, and may include wired or wireless sub-networks. Furthermore, market remote terminal 117, research remote terminal 127 and innovation remote terminal 147 may be included as part of the DSS 100, although these may be information resources provided from third party providers. The respective remote terminals are computing devices (e.g., desktop computers, virtual machines, cloud-based devices or smartphones that contain circuitry configured by software when executed therein), all having a circuit or circuitry-based processor (e.g., microprocessor, and/or ASIC, contained within one device, or distributed across multiple devices) and provide data to the DSS 100 wirelessly or over physical communication links. Likewise, PTO database 130 is a source of information that is provided to the innovation support apparatus 140. The PTO database 130 may be from a local PTO such as the USPTO, the Kingdom of Saudi Arabia (KSA) PTO, or any other regional or international patent database whether public or commercial, such as the GOOGLE patent database.

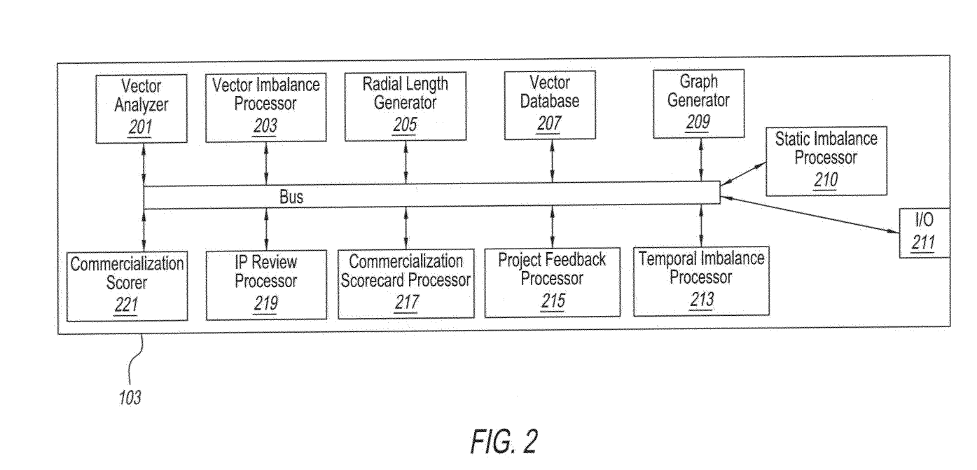

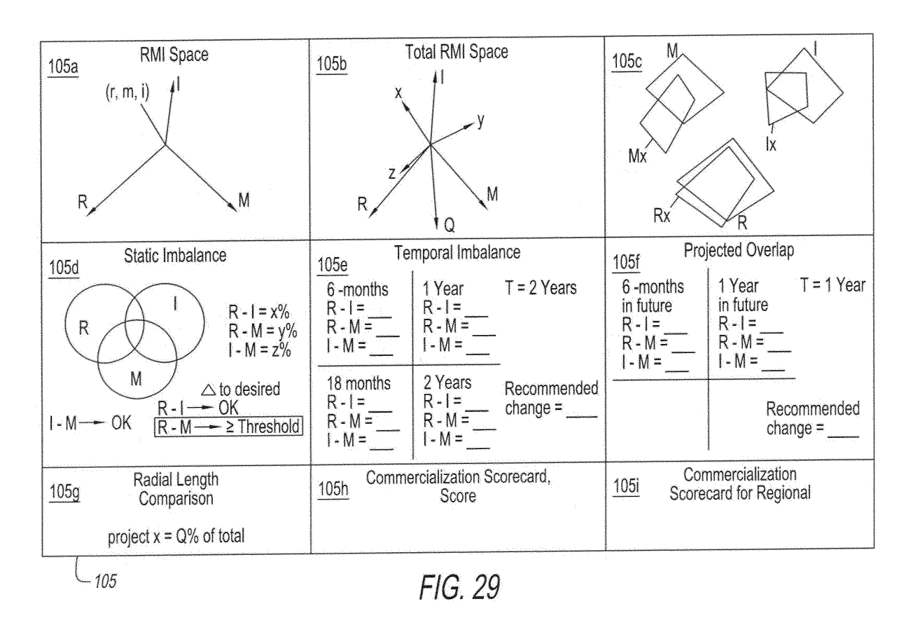

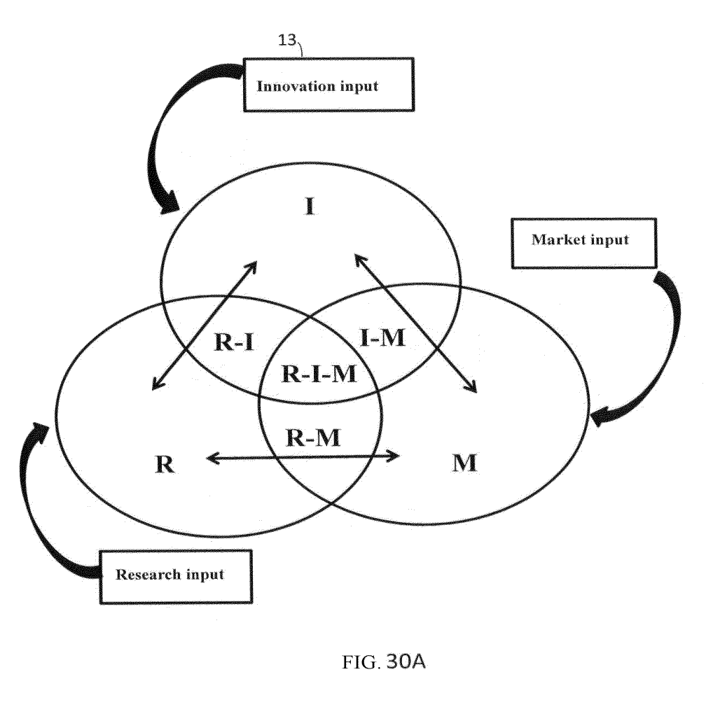

The decision support apparatus 101 includes an interface (I/O, or input/output) 107 that interconnects with the other devices via the communication network 150. The decision support apparatus 101 includes a DSA processor 103, which will be described in more detail with regard to FIG. 2. It also includes a GUI display 105, which will be described in more detail in FIG. 29. The decision support apparatus 101 receives information from each of the market support apparatus 110, research support apparatus 120, and innovation support apparatus 140. The DSA processor 103 performs a variety of functions as will be discussed, but in at least one context, performs analyses for particular projects or groups of projects regarding how research activities, market availability information and innovation processes overlap with one another (correspondence), and are then analyzed to determine the degree of overlap relative to predetermined overlap models. By detecting imbalances in each of the different spaces, namely research, market, and innovation, the decision support system 100 is able to provide meaningful feedback to a funding authority, management oversight authority, or project participants to better guide their activities to be in line with a goal of performing innovation and research in ways that greatly enhance the adoption of the ideas and research into commerce. Moreover, rather than have independent activities of innovation and research, the decision support system 100 supports a process of guiding the research activities and the innovation activities to increase the likelihood that these activities will provide a meaningful input into an active market, thus stimulating the knowledge economy.

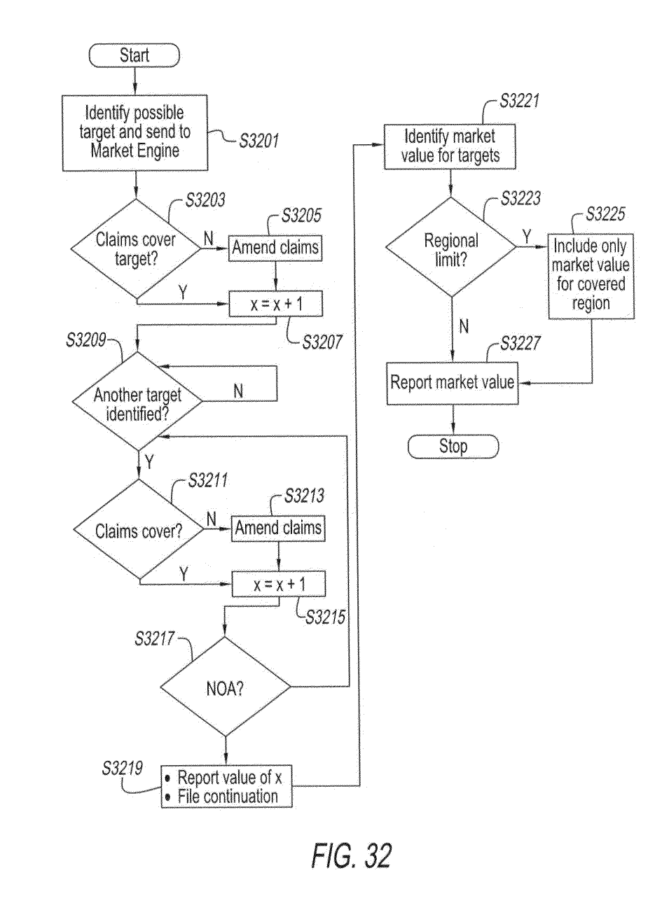

Market support apparatus 110 includes a market database 111 that provides input to and receives input from a market gathering engine 113. Data is exchanged with external systems by way of a market support apparatus interface 115. As will be discussed particularly with regard to FIGS. 32 and 34, a market remote terminal 117 provides information to the market database 111 and market gathering engine 113 to assist in identifying the space in the R-I-M space occupied by the market component.

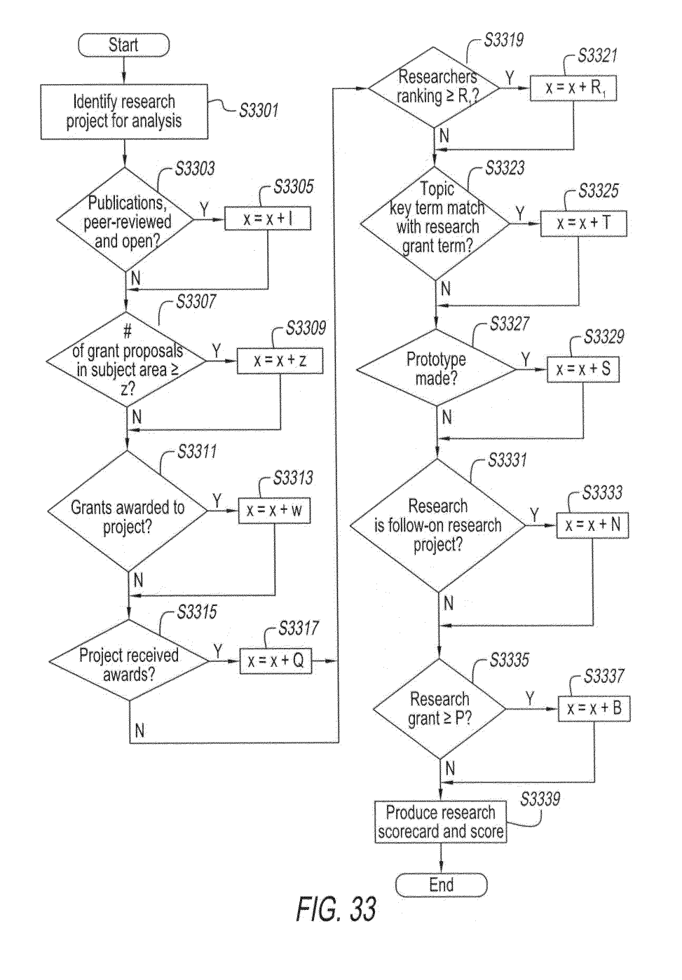

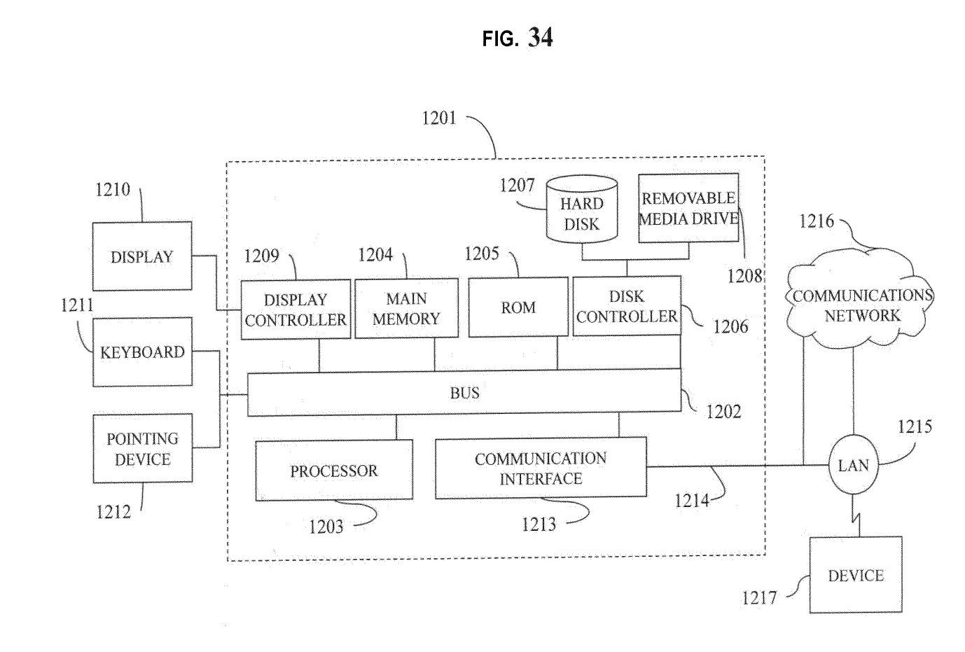

Similarly, the research support apparatus 120 includes a research database 121, research gathering engine 123, and interface 125 that interfaces with external devices and communication network 150. One of the external devices is the research remote terminal 127, which provides information regarding the particular research activity as will be discussed in greater detail with regard to FIGS. 33 and 34.

The innovation support apparatus 140 includes an internal innovation database 141 that holds information regarding present patent families for patents issued and pending that are relevant to the research and markets under analysis. The innovation gathering engine 143, as will be discussed in greater detail with regard to FIG. 32, performs an analysis on the research to determine the potential likelihood of being valuable in a market space so as to support commercialization either through licensing activity, attraction of joint ventures, or further promoting research in areas that have a proven market interest. The innovation support apparatus 140 receives information from an innovation remote terminal 147 regarding patenting activity. Likewise, PTO database 130 also is a source of information when analyzing the footprint of the space occupied in the innovation domain of the R-I-M space as will be discussed.

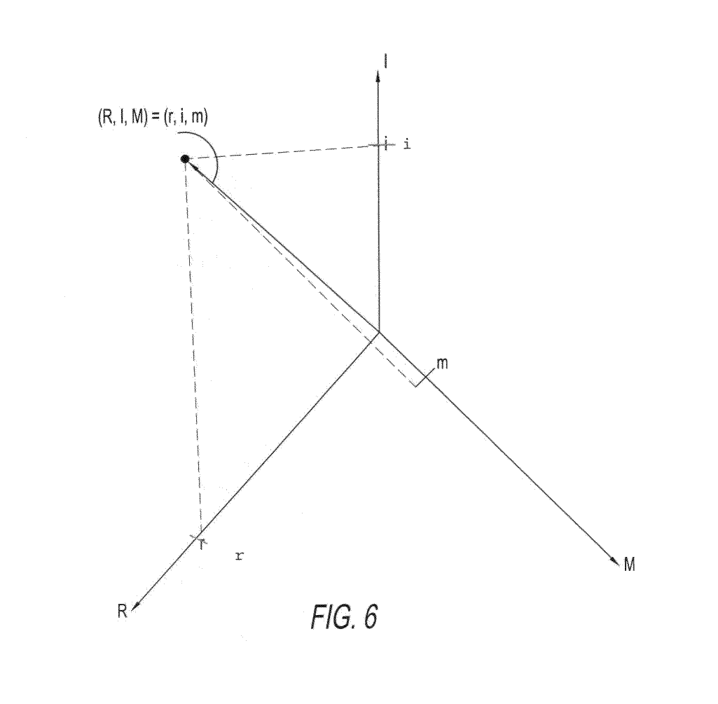

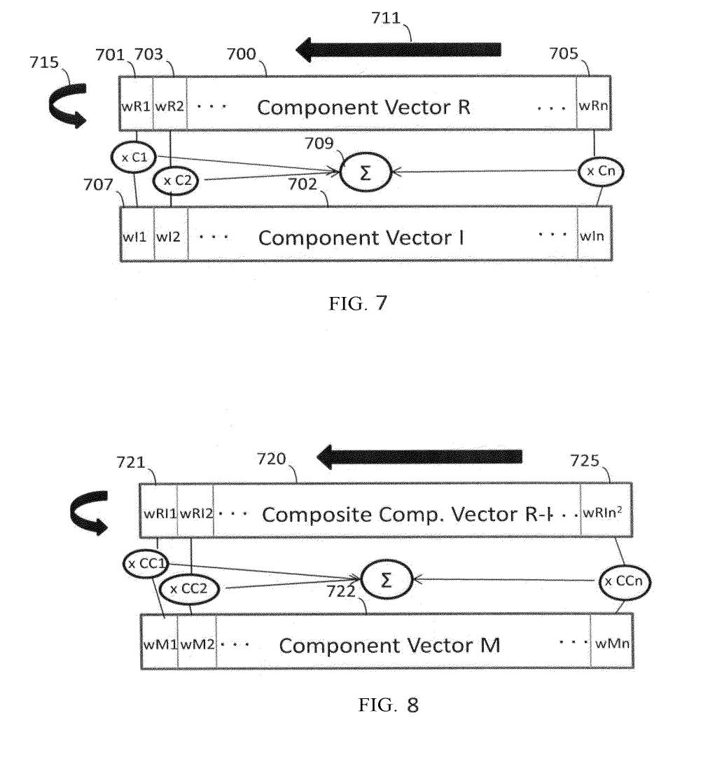

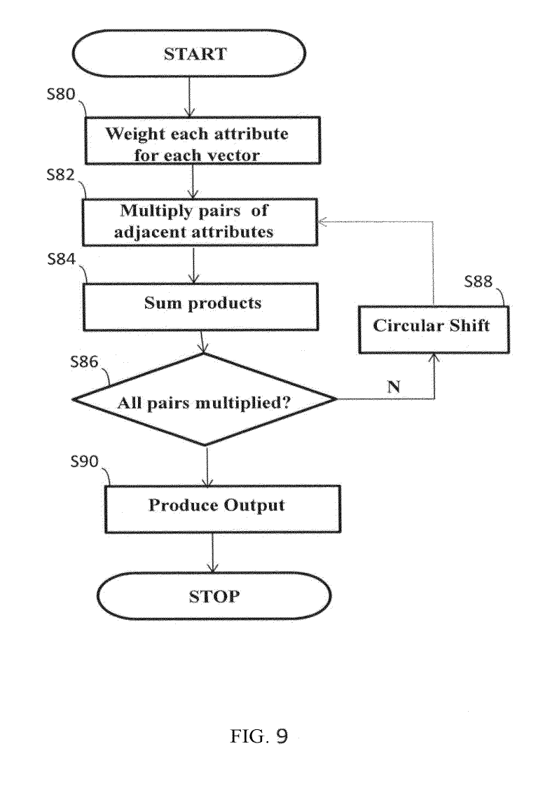

FIG. 2 is a block diagram of the decision support apparatus processor 103 (FIG. 1) which may be implemented on the circuitry of FIG. 34. The decision support apparatus processor 103 includes a vector analyzer 201 as will be discussed in greater detail with regard to FIG. 9. The vector analyzer performs functions such as that described in FIG. 6, as will be discussed, which maps a project-vector into R-I-M space. It also performs the functions described in FIGS. 7 and 8. The vector analyzer 201 communicates with the other processors and devices shown in FIG. 2, where communications are provided by way of an internal bus 223. An interface 211 provides external communication capability with external devices.

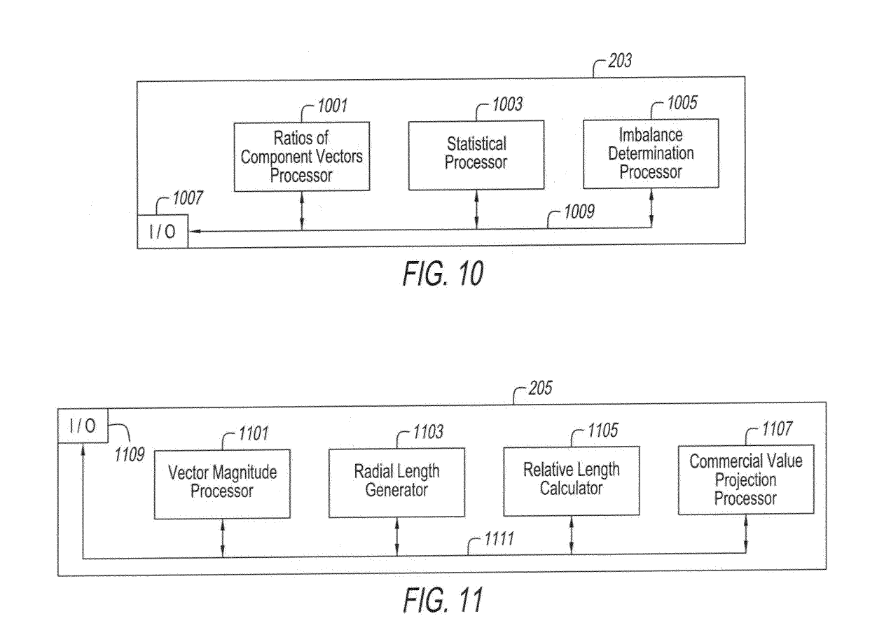

A vector imbalance processor 203 will be described in greater detail in FIG. 10. A function performed by the vector imbalance processor 203 is to assess the magnitude of imbalances in the R-I-M space for a project-vector, with respect to magnitude and relevance for each of the three domains (R-I-M).

A radial length generator 205 will be described in greater detail in FIG. 11. The radial length indicator shows a length of the project-vector in the R, M and I space, which is an indicator of the potential commercialization value, where a longer vector has a greater potential commercialization value than a smaller vector.

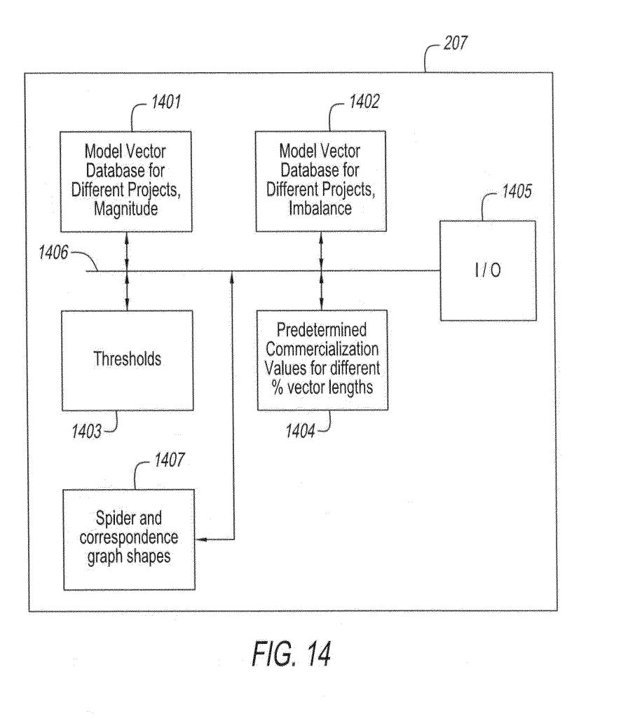

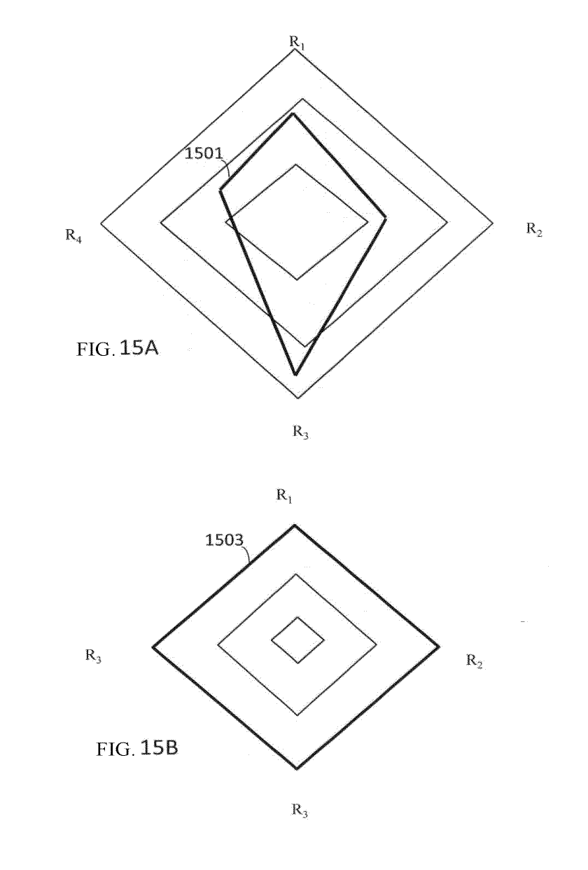

Vector database 207 will be described in greater detail with regard to FIG. 14. The database 207 includes model vector databases for different projects, including convergence shape as well as magnitude. The vector database 207 also includes thresholds used to determine amounts of imbalance in the R-I-M domain. Furthermore, the vector database 207 includes predetermined correspondence regions (overlaps in the correspondence diagrams). Furthermore, as will be discussed, the database 207 also includes exemplary spider graphs used for comparison purposes to detect amounts of imbalance for any particular constituent component, R-I-M.

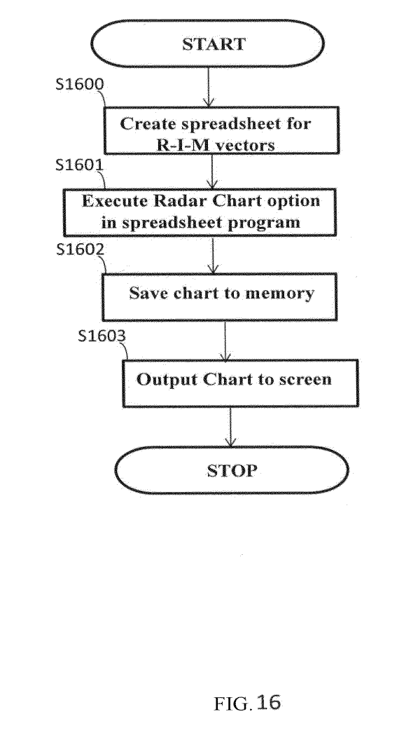

Graph generator 209 will be described in more detail in FIGS. 15 and 16. The graph generator 209 generates spider graphs and correspondence graphs, and FIG. 16 explains a process by which the graphs are generated.

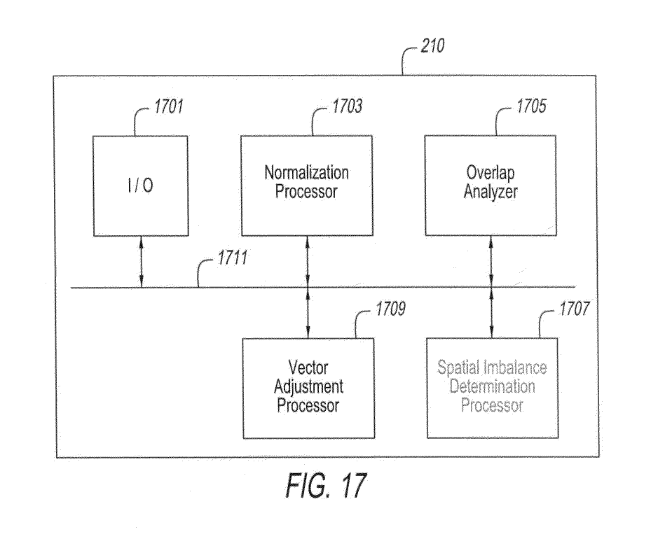

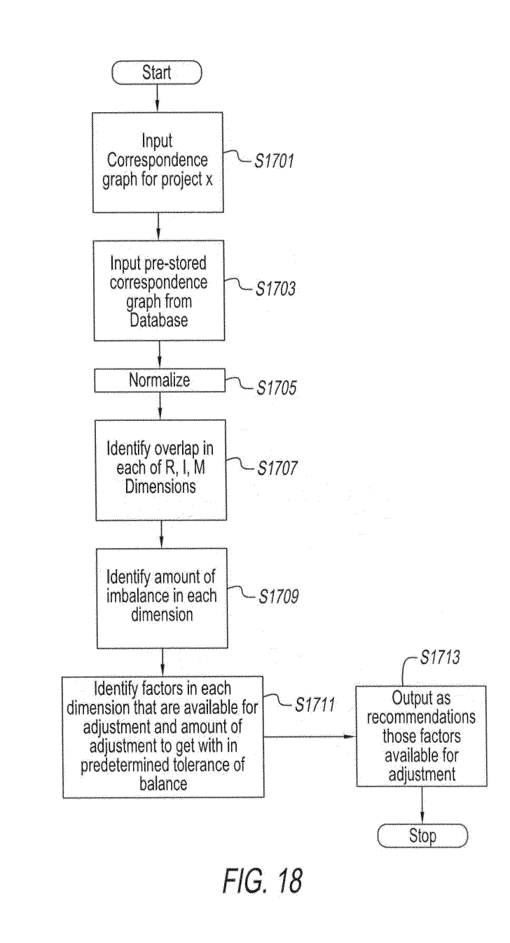

A static imbalance processor 210 will be described in more detail with regard to FIGS. 17 and 18. The static imbalance processor 210 identifies imbalances between a project-vector in the R-I-M space with respect to predetermined correspondence shapes so a degree of imbalance is identified. The term “static” means a snapshot at a particular time.

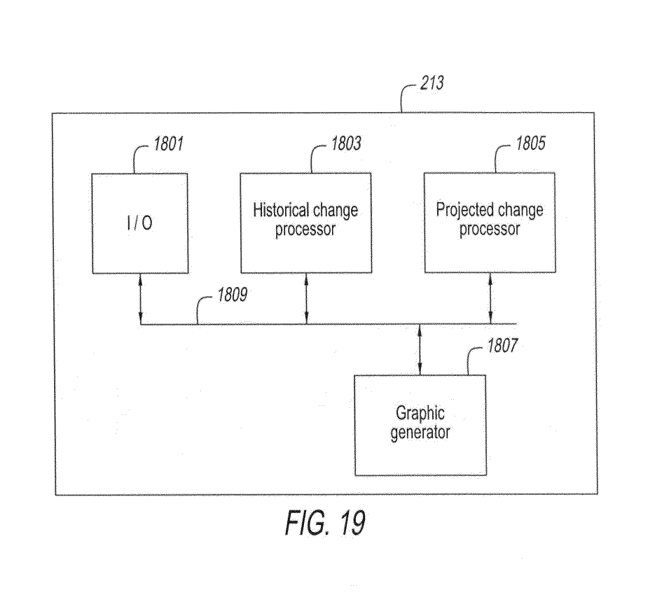

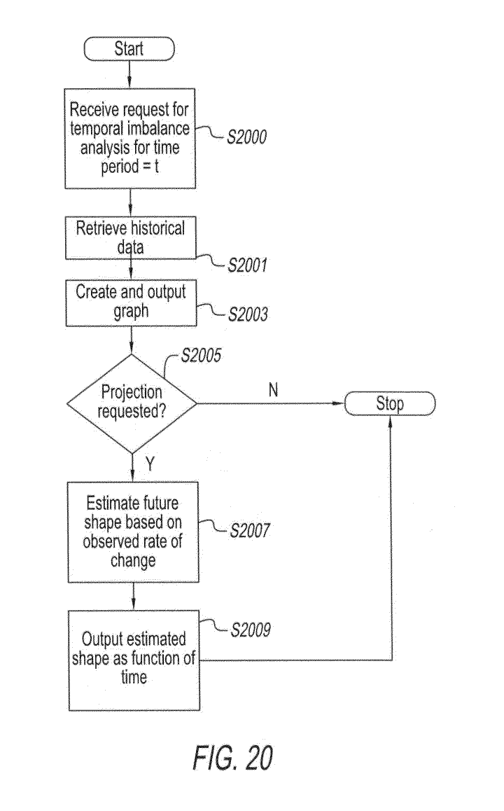

As opposed to a “static” imbalance processor, a temporal imbalance processor 213, as will be discussed in FIGS. 19 and 20, provides a visual review of how the imbalance in the R-I-M space changes over time, both retrospectively and prospectively.

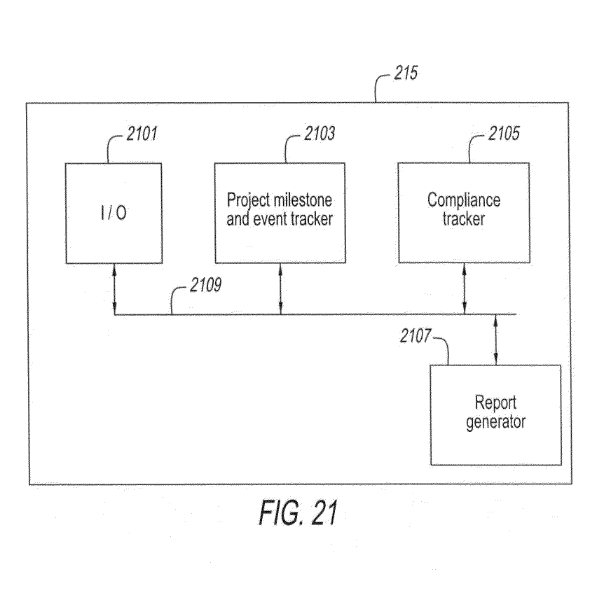

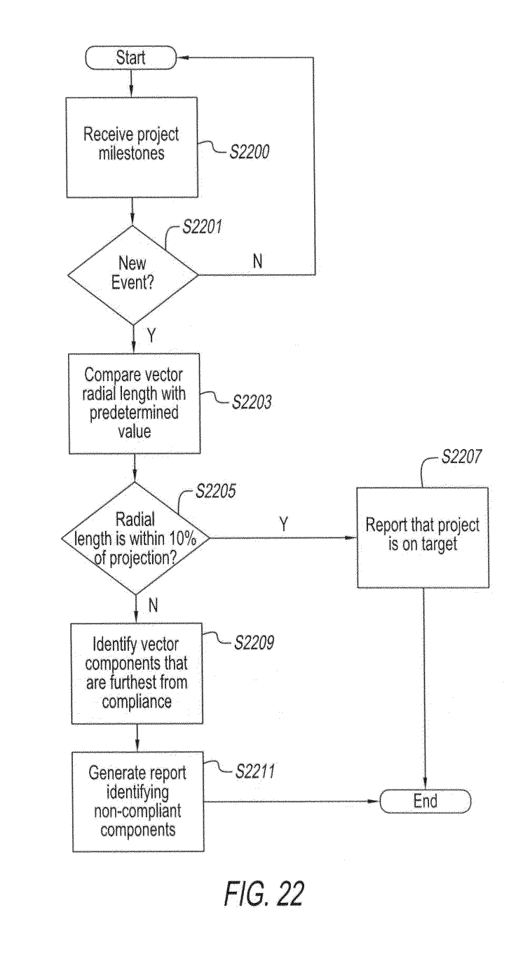

Project feedback processor 215 will be described in more detail with regard to FIGS. 21 and 22. The project feedback processor 215 generally provides feedback (e.g., to a project manager or a funding agency) regarding how well particular research and innovation efforts are proceeding with regard to predetermined research and innovation goals as they relate to perceived market acceptance.

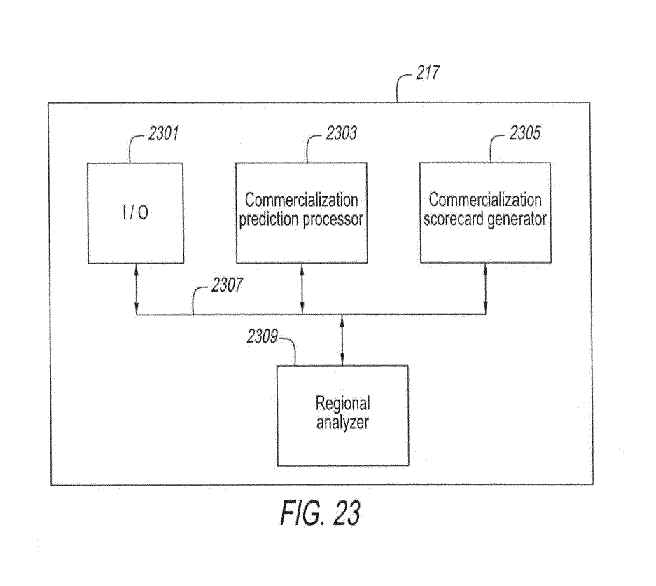

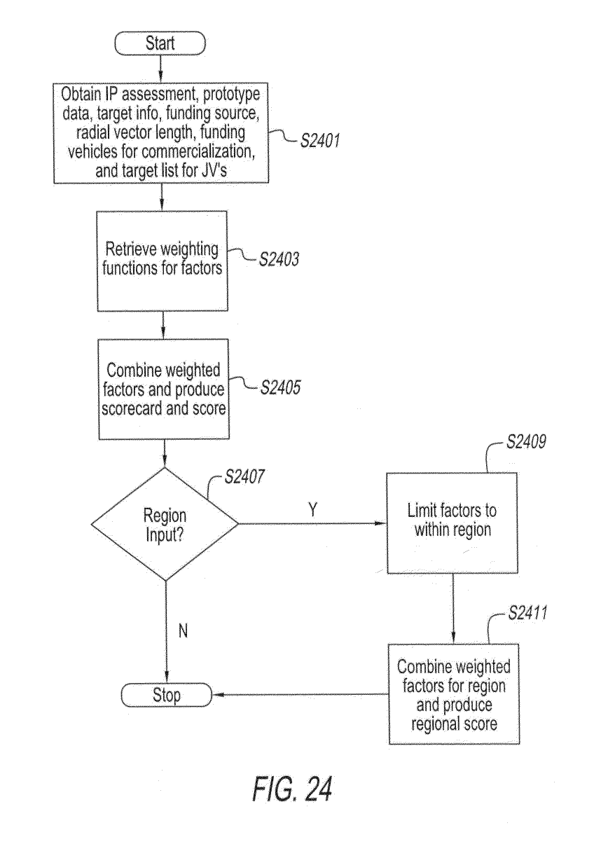

The DSA processor 103 also includes a commercialization scorecard processor 217 that generates for output a scorecard that indicates the performance of the research and innovation as they relate to the likelihood of being commercially relevant. The commercialization scorecard processor is described in more detail in FIG. 23 and the process performed by the scorecard process is described in greater detail with regard to FIG. 24.

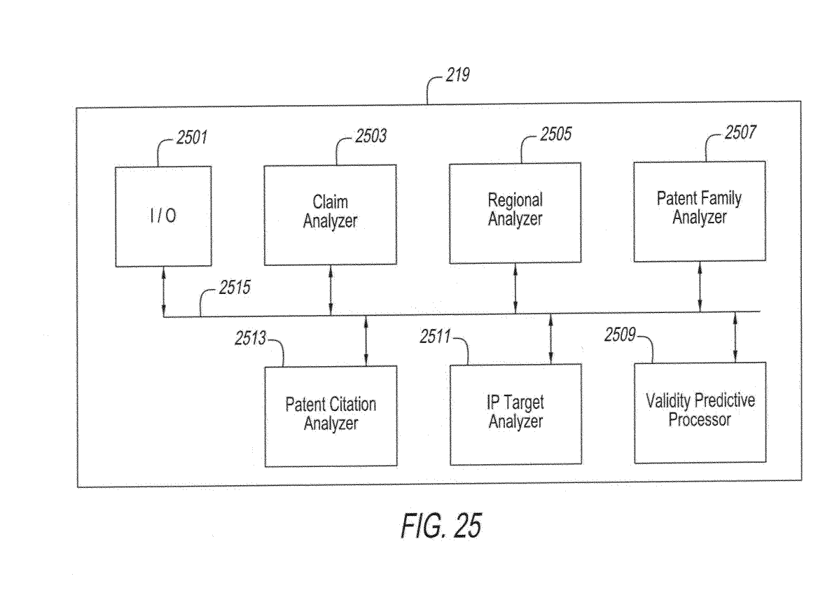

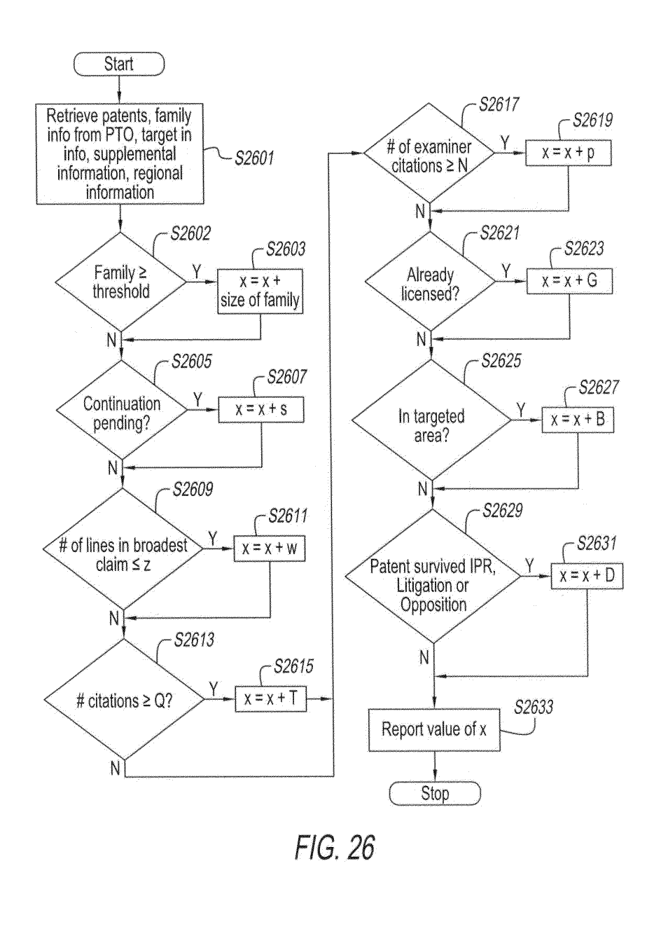

IP review processor 219 will be described in greater detail with regard to FIGS. 25 and 26. The IP review processor 219 uses information regarding whether intellectual property rights are secured and the strength of those rights with respect to the interest in commercialization and application to the research being performed.

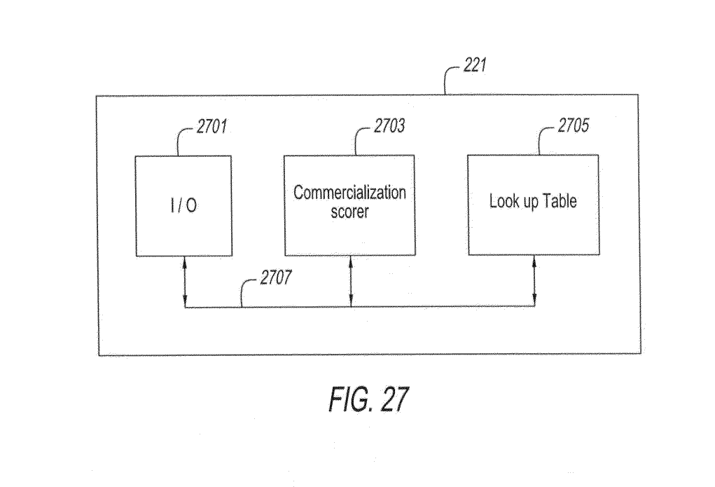

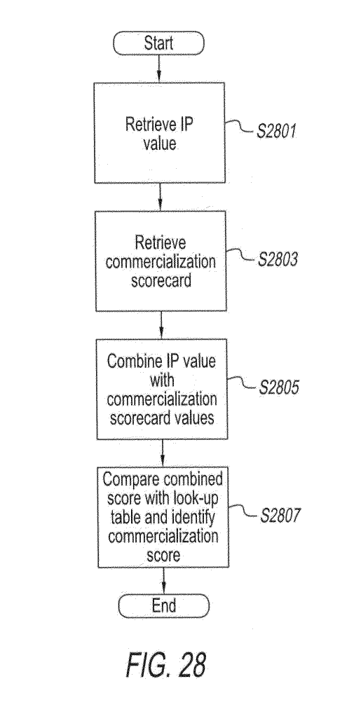

A commercialization scorer 221 will be described in more detail in FIG. 27 and the process performed by the commercialization scorer 221 will be described in more detail with regard to FIG. 28. Generally, the commercialization scorer 221 provides a general score for a rapid “dashboard” review by a project manager.

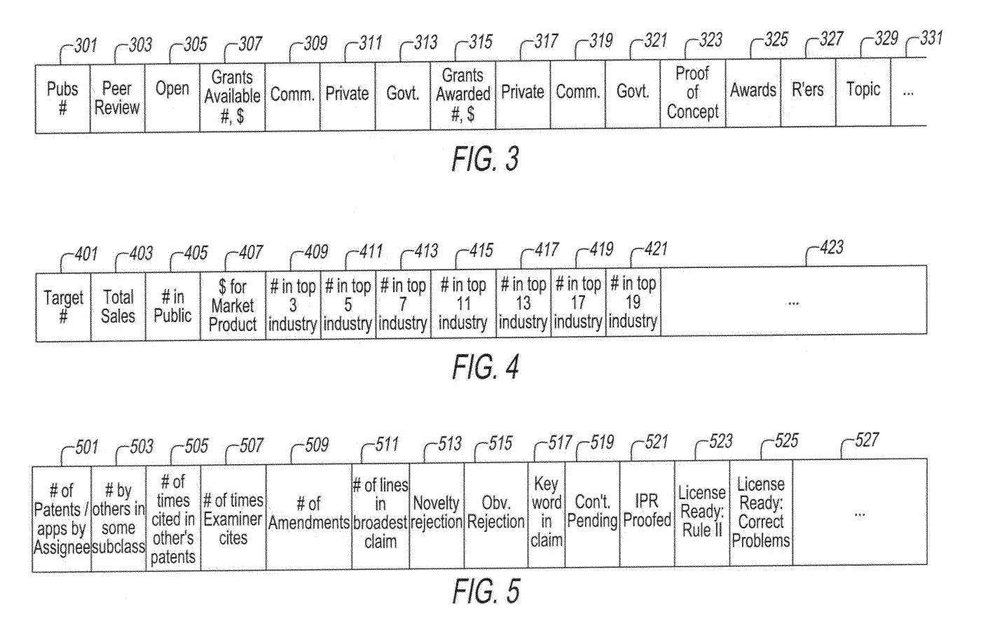

FIG. 3 is a data structure of the research attributes (or key performance indicators, KPI's) used to characterize the research domain of the R-I-M space. Each of the different attributes, or KPI's, which will soon be discussed, are used to characterize the constituent components. The research attributes may vary depending on the query asked of the DSS 100, such as whether a particular research project is likely to produce commercially valuable ideas that are protectable by IP and useful in the market. Moreover, the constituent components of the research vector is shown in FIG. 3, the components of the market domain are shown in FIG. 4, and the constituent components of the innovation domain are shown in FIG. 5.

With regard to FIG. 3, each of the components will now be discussed with regarding to including typical attributes. Attribute 301, R1, relates to a number of publications related to the subject research. The values for attribute R1 range between 0 and 1, and an example breakdown of how the values are mapped into the number of publications in the subject area is shown in TABLE 1. While the values are shown to range between 0 and 1, this has been done as a matter of convenience to normalize the impact of each attribute. Other ranges of values may be used as well, perhaps even without each attribute having a same range so that some attributes may be weighted more heavily than others.

TABLE 1

| RESEARCH | | |
|---|---|---|
| ATTRIBUTE, | # of publications in | VALUE |
| KPI, R1, 301 | subject area | Range 0 to 1 |
| R1, 301 | =0 | 0 |
| | 1 | .25 |
| | 2 to 4 | .5 |
| | 5 to 10 | .75 |
| | >10 | 1 |

Attribute 303 includes a subset of the publications, namely those that have been peer reviewed. Example values for R2 are shown in TABLE 2 below.

TABLE 2

| RESEARCH | # of peer reviewed | |
|---|---|---|
| ATTRIBUTE, | publications in subject | VALUE |
| KPI, R2, 303 | area | Range 0 to 1 |
| R2, 303 | =0 | 0 |
| | 1 | .35 |
| | 2 | .55 |
| | 3 | .75 |
| | >3 | 1 |

Attribute 305 includes another subset of the total publications, namely those that have not been peer reviewed. Example values for R3 are shown in TABLE 3 below.

TABLE 3

| RESEARCH | | |
|---|---|---|
| ATTRIBUTE, | # of open publications in | VALUE |
| KPI, R3, 305 | subject area | Range 0 to 1 |
| R3, 305 | =0 | 0 |
| | 1-2 | .25 |
| | 3 to 5 | .5 |
| | 6 to 12 | .75 |
| | >12 | 1 |

Attribute 307 includes the number of grants that are available in the research topic generally in terms of number of grants and the associated money for each of the grants, separately and in combination. Example values for R4 are shown in TABLE 4 below.

TABLE 4

| RESEARCH | | |
|---|---|---|
| ATTRIBUTE, | # of grants in subject | VALUE |
| KPI, R4, 307 | area | Range 0 to 1 |
| R4, 307 | =0 | 0 |
| | 1 | .25 |
| | 2 to 3 | .5 |
| | 4 to 6 | .75 |
| | >6 | 1 |

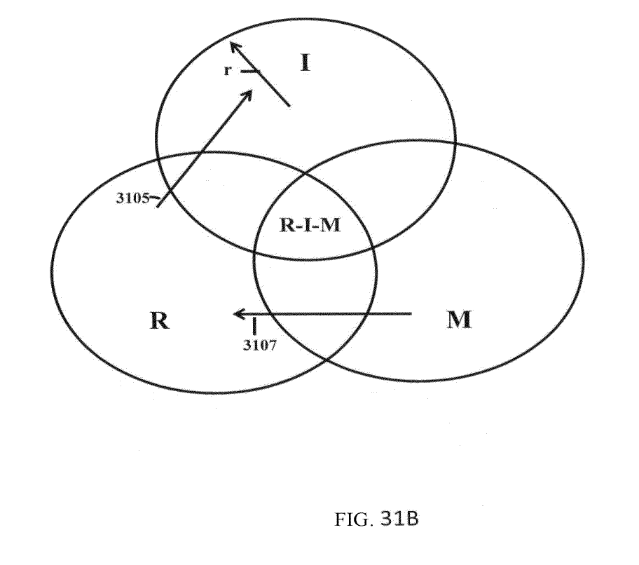

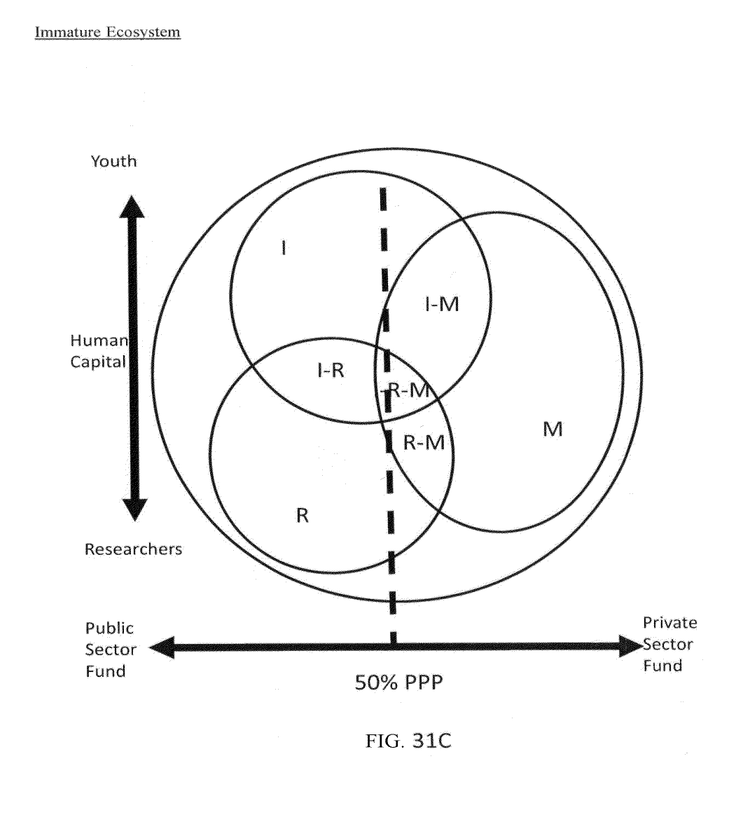

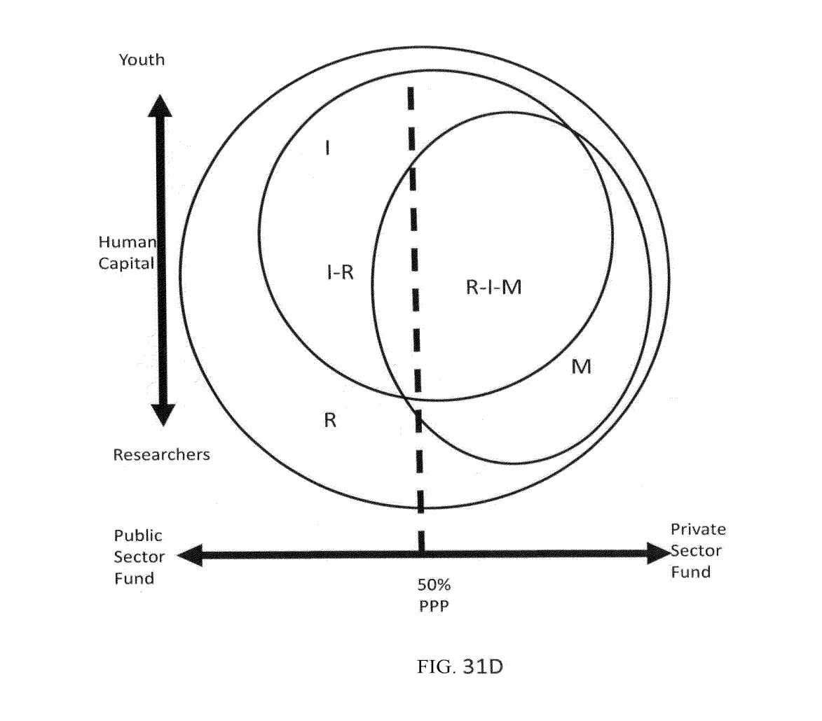

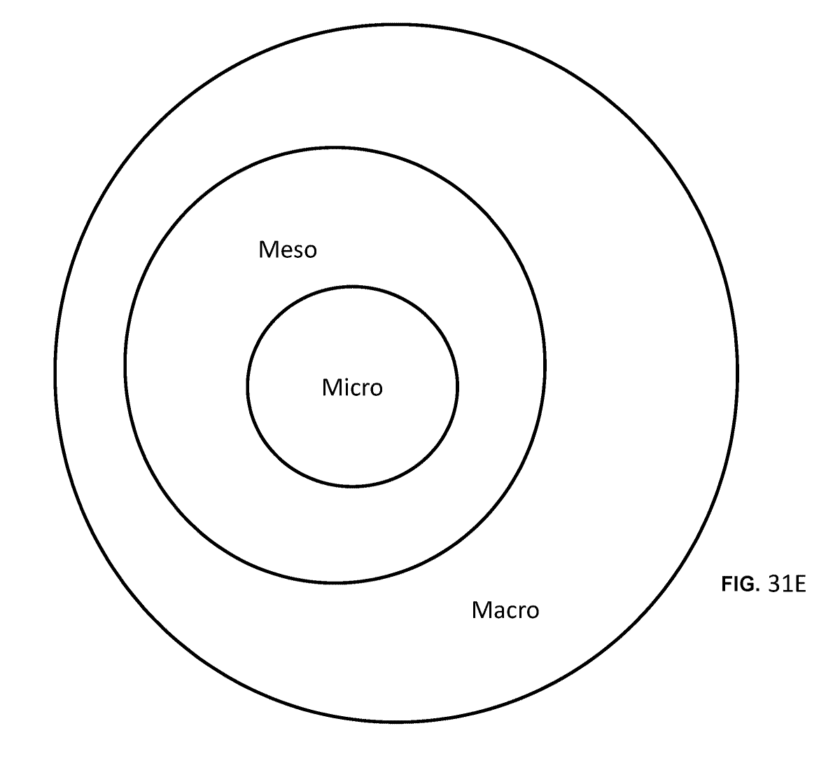

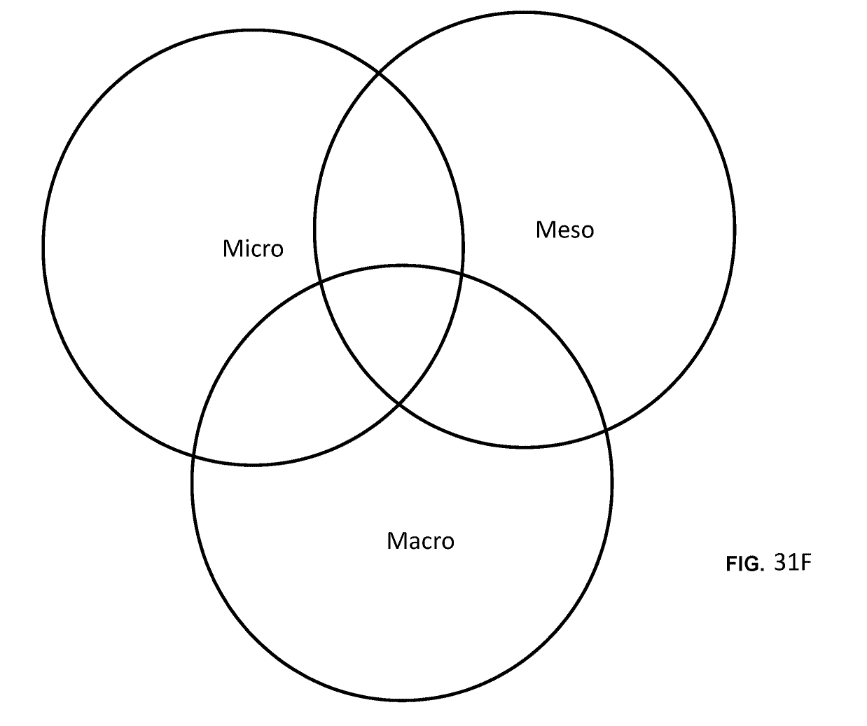

Attribute 309 is a subset of the grants available, with the grants being from commercial industry. As will be discussed with respect to FIG. 31F, the values shown in TABLE 5 may vary if a separate query is made regarding an analysis of micro, meso or macro level, or when determining whether the research project is a “push” or a “pull” candidate for market utilization. Similarly, the values for attributes 311 and 313 will vary, where for higher numbers of commercial grants, suggesting that there is market pull, and higher number of governmental grants, indicating that there is market push. While the term “market push” is used for convenience, it is to be understood that market push includes technology push. Likewise, higher numbers for attribute 311, are indicative of market pull. Example values for R5 are shown in TABLE 5 below.

TABLE 5

| RESEARCH | # of grants from | |
|---|---|---|
| ATTRIBUTE, | commercial sector in | VALUE |
| KPI, R5, 309 | subject area | Range 0 to 1 |
| R5, 309 | =0 | 0 |
| | 1 | .25 |
| | 2 | .5 |
| | 3 | .75 |
| | >3 | 1 |

Attribute 311 includes a subset of grants that have been privately funded. Example values for R6 are shown in TABLE 6 below.

TABLE 6

| RESEARCH | | |
|---|---|---|
| ATTRIBUTE, | # of grants from private | VALUE |
| KPI, R6, 311 | funding in subject area | Range 0 to 1 |
| R6, 311 | =0 | 0 |
| | 1 | .25 |
| | 2 | .5 |
| | 3 | .75 |
| | >3 | 1 |

Attribute 313 includes a number of grants that are provided by the government. Example values for R7 are shown in TABLE 7 below.

TABLE 7

| RESEARCH | # of grants from | |
|---|---|---|
| ATTRIBUTE, | commercial sector in | VALUE |
| KPI, R7, 313 | subject area | Range 0 to 1 |
| R7, 313 | =0 | 0 |
| | 1-3 | .25 |
| | 4-6 | .5 |
| | 7-9 | .75 |
| | >9 | 1 |

Attribute 315 amount of grant money awarded in terms of total amount to the particular research project involved. Example values for R8 are shown in TABLE 8 below.

TABLE 8

| RESEARCH | | |
|---|---|---|
| ATTRIBUTE, | $ granted to particular | VALUE |
| KPI, R8, 315 | research project | Range 0 to 1 |
| R8, 315 | =0 | 0 |
| | <$250,000 | .25 |
| | $250,000 < x < $500,000 | .5 |
| | $500,000 < x < $1M | .75 |
| | >$1M | 1 |

Attribute 317 includes a subset of the awarded grants, namely those provided by a private entity. Example values for R9 are shown in TABLE 9 below.

TABLE 9

| RESEARCH | $ granted to particular | |
|---|---|---|
| ATTRIBUTE, | research project by | VALUE |
| KPI, R9, 317 | private entity | Range 0 to 1 |
| R9, 317 | =0 | 0 |
| | <$250,000 | .25 |
| | $250,000 < x < $500,000 | .5 |
| | $500,000 < x < $1M | .75 |
| | >$1M | 1 |

Attribute 319 is a subset of awarded grants provided by the commercial sector. Example values for R10 are shown in TABLE 10 below.

TABLE 10

| RESEARCH | $ granted to particular | |
|---|---|---|
| ATTRIBUTE, | research project by | VALUE |
| KPI, R10, 319 | commercial entity | Range 0 to 1 |
| R10, 319 | =0 | 0 |
| | <$250,000 | .25 |
| | $250,000 < x < $500,000 | .5 |
| | $500,000 < x < $1M | .75 |
| | >$1M | 1 |

Attribute 321 is a subset of awarded grants provided by the government. Example values for R11 are shown in TABLE 11 below.

TABLE 11

| RESEARCH | $ granted to particular | |
|---|---|---|
| ATTRIBUTE, | research project by | VALUE |
| KPI, R11, 321 | government entity | Range 0 to 1 |
| R11, 321 | =0 | 0 |
| | <$250,000 | .25 |
| | $250,000 < x < $500,000 | .5 |
| | $500,000 < x < $1M | .75 |
| | >$1M | 1 |

Attribute 323 indicates whether or not a proof of concept model has been made and a full commercial ready prototype. Example values for R12 are shown in TABLE 12 below.

TABLE 12

| RESEARCH | | |
|---|---|---|
| ATTRIBUTE, | Proof of concept | VALUE |
| KPI, R12, 323 | successfully developed | Range 0 to 1 |
| R12, 323 | No | 0 |
| | In development | .25 |
| | Successful | .5 |
| | Commercial embodiment | 1 |

Attribute 325 is directed to identifying whether any awards have been granted to the research project. Example values for R13 are shown in TABLE 13 below.

TABLE 13

| RESEARCH | | |
|---|---|---|
| ATTRIBUTE, | | VALUE |
| KPI, R13, 325 | Industry awards received | Range 0 to 1 |
| R13, 325 | =0 | 0 |
| | 1 | .25 |
| | 2 to 3 | .5 |
| | 4 to 5 | .75 |
| | >5 | 1 |

Attribute 327 includes a listing of the researchers and their relative ranking in industry, the ranking being a particular notoriety for particular inventors such as the number of peer reviewed papers published, industry awards, etc. Also, the researchers 327 are broken down by academic researchers and commercial researchers. This breakdown is relevant, as the commercial researchers may have a greater likelihood of involving the research project in a commercially funded endeavor. Example values for R14 are shown in TABLE 14 below.

TABLE 14

| RESEARCH | | |
|---|---|---|
| ATTRIBUTE, | $ granted to particular | VALUE |
| KPI, R14, 327 | researcher ranking | Range 0 to 1 |
| R14, 327 | Unknown | 0 |
| | At least 1 Senior status | .25 |
| | At least one Fellow | .5 |
| | status | |
| | At least two Fellow status | .75 |
| | Nobel Prize | 1 |

Attribute 329 includes identifying keywords with regard to the topic of the research as it relates to other news publications and grants, as it relates to the research being performed. Example values for R15 are shown in TABLE 15 below.

TABLE 15

| RESEARCH | | |
|---|---|---|
| ATTRIBUTE, | # of keywords on the | VALUE |
| KPI, R15, 329 | research topic | Range 0 to 1 |
| R15, 329 | =0 to 2 | 0 |
| | >2 | .25 |
| | >4 | .5 |
| | >6 | .75 |
| | >8 | 1 |

Attribute(s) 331 are expansion attributes that may compliment the other attributes included in FIG. 3. Examples of these expansion attributes include human capital, laboratory resources, financial resources, skill base, hits on social media regarding the research project, attendees at conferences on the topic of the research as well as other attributes. These too would have exemplary value ranges between 0 and 1.

FIG. 4 is a data structure of a market vector that includes attributes (KPI's) regarding the market that may be relevant to the research and innovation being performed on the topic space. A number of attributes in the market may be used for determining whether a particular market vector reflects a market push or market pull for a particular product or industry. For example, total sales 403, being above a predetermined level, such as $100,000, would indicate that there was market pull for that particular product or service. For values less than the $100,000 it would indicate that there was market push indicating that the market is not yet mature, or has not yet been created for that particular product or service. Similarly, the number of targets in the public 405, having values (see TABLE 18), less than 0.5, would indicate market push, rather than market pull. Similarly, values identified in the respective tables associated with the other attributes, having values less than 0.5 would indicate market push, where values over 0.5 would indicate market pull.

Attribute 521, I11, relates to whether the application or patent has been subject to a post grant review or interparte review, challenged in litigation, or in an opposition proceeding.

Attribute 523, I12, is in indication whether a rule 11 analysis has been performed.

Attribute 525, I13, indicates whether corrective action has been taken on the patent or application to correct identified problems.

Attribute 401, M1, includes the number of targets included in the target database, as will be discussed. Values for attribute M1 are shown in Table 16.

TABLE 16

| MARKET | | |
|---|---|---|
| ATTRIBUTE, | # of targets in Market | VALUE |
| KPI, M1, 401 | database | Range 0 to 1 |
| M1, 401 | =0 | 0 |
| | 1 | .5 |
| | >1 | 1 |

Attribute 403, M2, is directed to the total amount of sales of product and services included in the target database for the relevant topic space.

TABLE 17

| MARKET | | |
|---|---|---|
| ATTRIBUTE, | | VALUE |
| KPI, M2, 403 | $ sales | Range 0 to 1 |
| M2, 403 | =0 | 0 |
| | <$250,000 | .25 |
| | $250,000 < x < $500,000 | .5 |
| | $500,000 < x < $750,000 | .75 |
| | >$750,000 | 1 |

Attribute 405, M3, includes a total number of targets available to the public regarding the topic space.

TABLE 18

| MARKET | | |
|---|---|---|
| ATTRIBUTE, | | VALUE |
| KPI, M3, 405 | # of targets | Range 0 to 1 |
| M3, 405 | =0 | 0 |
| | 1 | .25 |
| | 2 | .5 |
| | 3 | .75 |
| | >3 | 1 |

Attribute 407, M4, includes a market size for the product or service included within the target market space.

TABLE 19

| MARKET | | |
|---|---|---|
| ATTRIBUTE, | | VALUE |
| KPI, M4, 407 | # of targets | Range 0 to 1 |
| M4, 407 | =0 | 0 |
| | 0 < x < $100,000 | .25 |
| | $100,000 < x < $200,000 | .5 |
| | $200,000 < x < $300,000 | .75 |
| | >$300,000 | 1 |

Attribute 409, M5, includes the number of entities identified in the target market space that are in the top three in the relevant industry. This is relevant to determine whether the research is guided in a same area as that dictated by industry leaders. Each of attributes 411, 413, 415, 417, 419 and 421 (M6, M7, M8, M9, M10, and M11 respectively) are similar to attribute 409, but include the number in the target database for the top 5, 7, 11, 13, 17 and 19 in the relevant industry. These values are relevant, as the top industry numbers presumably have greater influence and market capitalization since they are the leaders in the industry. Lower industry numbers are expected to have a lower market capitalization and lower likelihood of being a significant player in an industry. Values for M6, M7, M8, M9, M10, and M11 are shown in Tables 21-26 respectively.

TABLE 20

| MARKET | | |
|---|---|---|
| ATTRIBUTE, | | VALUE |
| KPI, M5, 409 | # of targets in top 3 | Range 0 to 1 |
| M5, 409 | =0 | 0 |
| | 1 | .5 |
| | >1 | 1 |

TABLE 21

| MARKET | | |
|---|---|---|
| ATTRIBUTE, | | VALUE |
| KPI, M6, 411 | # of targets in top 5 | Range 0 to 1 |
| M6, 411 | =0 | 0 |
| | 1 | .5 |
| | >1 | 1 |

TABLE 22

| MARKET | | |
|---|---|---|
| ATTRIBUTE, | | VALUE |
| KPI, M7, 413 | # of targets in top 7 | Range 0 to 1 |
| M7, 413 | =0 | 0 |
| | 1 to 2 | .5 |
| | >2 | 1 |

TABLE 23

| MARKET | | |
|---|---|---|
| ATTRIBUTE, | | VALUE |
| KPI, M8, 415 | # of targets in top 11 | Range 0 to 1 |
| M8, 415 | =0 | 0 |
| | 1 to 3 | .5 |
| | >3 | 1 |

TABLE 24

| MARKET | | |
|---|---|---|
| ATTRIBUTE, | | VALUE |
| KPI, M9, 417 | # of targets in top 13 | Range 0 to 1 |
| M9, 417 | =0 | 0 |
| | 1 to 4 | .5 |
| | >4 | 1 |

TABLE 25

| MARKET | | |
|---|---|---|
| ATTRIBUTE, | | VALUE |
| KPI, M10, 419 | # of targets in top 17 | Range 0 to 1 |
| M10, 419 | =0 | 0 |
| | 1 to 5 | .5 |
| | >5 | 1 |

TABLE 26

| MARKET | | |
|---|---|---|
| ATTRIBUTE, | | VALUE |
| KPI, M11, 421 | # of targets in top 19 | Range 0 to 1 |
| M11, 421 | =0 | 0 |
| | 1 to 6 | .5 |
| | >6 | 1 |

Attribute(s) 423 is an expansion attribute(s) and may include expressions of market need, knowledge exchange, market dynamics, entrepreneurial skill, regulatory and compliance issues, geo political factors, etc.

FIG. 5 includes the attributes of the innovation domain used to characterize the “I” space in the R-I-M space.

Attribute 501, I1, includes the numbers of patents and/or applications that have issued to, or been filed on behalf of, the assignee in the relevant subject space. This attribute can be broken down regionally, such as the US, China, Europe, Kingdom of Saudi Arabia, etc. Example values for I1 are shown in Table 27.

Attribute 503, I2, includes the number of applications or patents by others in the same classification (e.g., Class and subclass) as the patents and applications for the assignee. This attribute may be expressed in the form of a percentage, for example. Example values for I1 are shown in Table 28.

Attribute 505, I3, is a measure of the number of times the application or patent is cited in patents of others, which is an indication of how pioneering others consider the patent to be. Example values for I1 are shown in Table 29.

Attribute 507, I4, is directed to the number of times an Examiner cites a subject patent or application of the subject innovator against the patent applications (or patents) of others. This, in turn, is an indication of how an objective third party with access to public and protected invention information believes a subject patent might be to others in the industry. Example values for I1 are shown in Table 30.

Attribute 509, I5, is directed to the number of amendments that have been made in an application for a patent, the more amendments, the more likely the patent has limited scope. Example values for I1 are shown in Table 31.

Attribute 511, I6, is directed to the number of lines in the broadest claim for the patent. A smaller number of lines is presumably broader in scope than a claim with more lines. Example values for I1 are shown in Table 32.

Attribute 513, I7, is directed to whether a novelty rejection has been made based on prior art, indicating that the claims are perhaps overly broad. Example values for I1 are shown in Table 33.

Attribute 515, I8, is a component to identify whether one or more obviousness rejections have been made against the subject claim. Example values for I1 are shown in Table 34.

Attribute 517, I9, is directed to whether the claim includes a key word that also relates to market and/or research in the R-I-M space. Example values for I1 are shown in Table 35.

Attribute 519, I10, is a field indicating whether a continuation application or other family member is pending. Having a continuation application pending can often be helpful during licensing negotiations. This is because potential flaws pointed out by the potential licensee in the issued patent can possibly be addressed in the pending continuation application. Likewise, newly discovered prior art can be brought to the examiner's attention in the form of an information disclosure statement so the examiner has the benefit of reviewing the prior art and considering whether the claims are patentable over the newly discovered prior art. If not, then the claims can be amended so only valid claims are the subject of subsequent licensing discussions.

Attribute 501, I1, is an indication of the number of patents issued to the assignee in the relevant subject space. Example values for I1 are shown in Table 27.

TABLE 27

| INNOVATION | | |
|---|---|---|
| ATTRIBUTE, | # of Patents or | VALUE |
| KPI, I1, 501 | Applications | Range 0 to 1 |
| I1, 501 | =0 | 0 |
| | 1 | .5 |
| | 1 < x < 2 | .75 |
| | >2 | 1 |

Attribute 503, I2, indicates the number of times the patent has been cited by others in the same subclass. Example values for I2 are shown in Table 28.

TABLE 28

| INNOVATION | # of Patents or | |
|---|---|---|
| ATTRIBUTE, | Applications | VALUE |
| KPI, I2, 503 | by others | Range 0 to 1 |
| I2, 503 | >100 | 0 |
| | 25 < x < 100 | .25 |
| | 10 < x < 25 | .5 |
| | 5 < x < 10 | .75 |
| | <5 | 1 |

Attribute 505, I3, includes an indication as to the number of times the patent has been cited in others' patents. Example values for I3 are shown in Table 29.

TABLE 29

| INNOVATION | | |
|---|---|---|
| ATTRIBUTE, | # of times cited | VALUE |
| KPI, I3, 505 | by others | Range 0 to 1 |
| I3, 505 | 0 | 0 |
| | 1 < x < 2 | .25 |
| | 2 < x < 4 | .5 |
| | 4 < x < 10 | .75 |
| | >10 | 1 |

Attribute 527, I14, is an expansion attribute, and can include attributes such as whether a white space analysis has been performed; whether a freedom to operate analysis has been performed in the relevant region. The values assigned can be binary.

Attributes I5-I13 (associated with attributes 507, 509, 511, 513, 515, 517, 519, 521, 523, and 525 respectively) are shown in Tables 30-39 below.

TABLE 30

| INNOVATION | | |
|---|---|---|
| ATTRIBUTE, | # of times cited | VALUE |
| KPI, I4, 507 | by Examiner | Range 0 to 1 |
| I4, 507 | 0 | 0 |
| | 1 < x < 2 | .25 |
| | 2 < x < 4 | .5 |
| | 4 < x < 10 | .75 |
| | >10 | 1 |

TABLE 31

| INNOVATION | | |
|---|---|---|
| ATTRIBUTE, | | VALUE |
| KPI, I5, 509 | # of amendments | Range 0 to 1 |
| I5, 509 | >3 | 0 |
| | 2 < x < 3 | .25 |
| | 1 < x < 2 | .5 |
| | 1 | .75 |
| | 0 | 1 |

TABLE 32

| INNOVATION | | |
|---|---|---|
| ATTRIBUTE, | # of lines of | VALUE |
| KPI, I6, 511 | broadest claim | Range 0 to 1 |
| I6, 511 | >25 | 0 |
| | 20 < x < 25 | .25 |
| | 17 < x < 20 | .5 |
| | 12 < x < 17 | .75 |
| | <12 | 1 |

TABLE 33

| INNOVATION | | |
|---|---|---|
| ATTRIBUTE, | # of novelty | VALUE |
| KPI, I7, 513 | rejections | Range 0 to 1 |
| I7, 513 | >2 | 0 |
| | 1 < x < 2 | .5 |
| | 1 | .75 |
| | 0 | 1 |

TABLE 34

| INNOVATION | | |
|---|---|---|
| ATTRIBUTE, | # of obviousness | VALUE |
| KPI, I8, 515 | rejections | Range 0 to 1 |
| I8, 515 | >2 | 0 |
| | 1 < x < 2 | .5 |
| | 1 | .75 |
| | 0 | 1 |

TABLE 35

| INNOVATION | | |
|---|---|---|
| ATTRIBUTE, | | VALUE |
| KPI, I9, 517 | # of key words | Range 0 to 1 |
| I9, 517 | 0 | 0 |
| | 1 < x < 2 | .5 |
| | 2 < x < 4 | .75 |
| | >4 | 1 |

TABLE 36

| INNOVATION | | |
|---|---|---|
| ATTRIBUTE, | Continuations | VALUE |
| KPI, I10, 519 | pending | Range 0 to 1 |
| I10, 519 | 0 | 0 |
| | 1 | .5 |
| | 2 | .75 |
| | >2 | 1 |

TABLE 37

| INNOVATION | | |
|---|---|---|
| ATTRIBUTE, | Patent | VALUE |
| KPI, I11, 521 | challenges | Range 0 to 1 |
| I11, 521 | 0 | 0 |
| | 1 | .5 |
| | 2 | 1 |

TABLE 38

| INNOVATION | | |
|---|---|---|
| ATTRIBUTE, | Rule 11 analysis | VALUE |
| KPI, I12, 523 | performed? | Range 0 to 1 |
| I12, 523 | No | 0 |
| | Yes | 1 |

TABLE 39

| INNOVATION | | |
|---|---|---|
| ATTRIBUTE, | Corrective action | VALUE |
| KPI, I13, 525 | performed? | Range 0 to 1 |
| I13, 525 | No | 0 |
| | Yes | 1 |

FIG. 6 is a graph of a project-vector having components R, I, M, in a project space. As seen, the project has greater magnitudes of R and I than it does of M. However, the combined magnitude of the R-I-M project vector can still be quite large even one or two of the components is not large. If this is the case, it means that there are significant resources devoted to that project (or should be if the M is the largest component). Accordingly, the magnitude of the project vector (all three components included) is an indication of how much attention a project should be given in light of the resources that are either being devoted to it, or that should be devoted to it.

As will be discussed, there may also be an imbalance with regard to the amount of market relevance that the innovation and the research has been performed. Although this will be discussed later with regard to the imbalance processing, FIG. 6 is one graphical example of how the larger values of R and I may not be warranted in light of the smaller magnitude of the M component vector. Thus, this project may need to be refocused in terms of the amount of research being performed and IP being sought.

Although there are different axes R, I, M shown, these axes are not necessarily orthogonal, but instead have some attributes in one of the component vectors (R, I or M) that are correlated with other attributes in other component vectors. Nevertheless, in order to identify how a particular project maps into the three domains, a mapping process is performed to see how the project-vector maps into each of the three spaces, R-I-M. The magnitude of the component vectors along each axis is a function of the additive values of the attributes that make up the vector. For example, in the I component vector, the range of values of pending patent applications may be 0 to 20, for example. The maximum contribution to the magnitude of the I component vector is if the project has 20 or more pending applications. This particular attribute (pending applications) will then be weighted based on a weighting table (as will be discussed) to help normalize the amount of contribution that attribute may have relative to other attributes that make up the component vector.

FIG. 7A shows correlation circuitry that illustrates how pairs of component vectors (R-I, R-M, and I-M) are compared to one another to arrive at the overlap areas (areas 25, 27, and 29) in FIGS. 1B, 1C, and 1D respectively. FIG. 7A includes component vector R 700 (stored in a shift register) with exemplary weighted attributes w₁ᵣR1 701, w₂ᵣR2, and wₙᵣRn (the weights are shown for brevity in the Figure as “w”), although other weighted attributes would be included in the process. The respective weights are set based on the query made (e.g., What is the likelihood of obtaining a patent with immediate commercial potential?) to account for the relative influence that attribute should have in the comparing and vector correlation process. Component vector I 702 includes similar weighted attributes, such as w₁ᵢI1. Weighting the attributes adjusts the spatial size associated with that particular attribute, thus affecting the potential size of the correspondence graph for that particular vector (e.g., it affects how big the R shape is on the correspondence vector, for example). Weighting the correlation calculations adjusts the relative contributions each pair of attributes (e.g., R1, M1) contributes to an overlap area in the correspondence graph (e.g., the R-M overlap area).

In a first multiplication step, w₁ᵣR1 701 is multiplied with w₁ᵢI1 707, and the product is multiplied by a correlation weight C1 and the result sent to an accumulator (summation device) 709. The correlation weight C1 is a coefficient that adjusts the level of relevance for the matching pair for the query made. The products from the other matching pairs of weighted attributes from the vectors are multiplied (e.g., w₂ᵣR2×w₂ᵢI2 . . . wₙᵣRn×wₙᵢIn), adjusted by their respective correlation weight (Cx, x being an index), and summed in the accumulator 709. Then the weighted attributes in one vector (component vector R 700 in this example) are shifted left 711 by one position and then are multiplied by the corresponding weighted attribute in component vector I 702 and correlation weight C2. For example, in the second step w₂ᵣR2 703 is multiplied by w₁ᵢI1 707 and the product is multiplied by a correlation weight Cx and the result is summed with the other products in the accumulator 709. The one exception is that the left most weighted attribute (which in this case is w₁ᵣR1) is circular shifted right 715 so as to take the position of wₙᵣRn 705. This process continues until all of the weighted attributes of one vector are multiplied, adjusted by a correlation weight, and summed with all the other attributes of the other component vector.

With regard to the weights, each attribute of each vector is first weighted such that each attribute is either weighted with a 0 or a value between zero and 1. A zero value means that the subject attribute does not contribute at all. Values closer to 1 are deemed to be associated with attributes that have a higher relevance toward successful commercialization. Each attribute of each vector is then combined (multiplied in this example, but could also be added or combined in another mathematical fashion) with each attribute of the other component vectors, and a resultant sum is obtained. The weighted vector correlation of the R and I component vectors results in the overlap area 25 (FIG. 1B). A similar weighted vector correlation of the R and the M component vectors is also performed and results in the overlap area 27 (FIG. 1C). The weighted vector correlation of the I and the M component vectors is also performed and results in the overlap area 29 (FIG. 1D).

While in the above-described embodiment, there a fixed weight is assigned to each attribute for each component vector. However, for an even more refined correlation process, a separate weight is applied for each attribute for each multiplication performed. For example, there may be a high correlation between peer reviewed papers (an R space attribute) and number of patent applications. However, there may be little correlation weight for amount of laboratory resources (R space attribute) and length of patent claim (I space).

FIG. 8 is similar to FIG. 7 although it illustrates a correlation process (using weights CCx) for a composite component vector R-I 720 with component vector M 722. The weighted vector correlation of the R, I and M vectors results in the overlap area 31 (FIG. 1E). The only difference with this process is that the composite component vector R-I is formed as a vector, and if each of the component vectors has n attributes, then the composite component vector R-I 720 will have n² attributes. Thus, the first attribute of composite component vector R-I is w₁ᵣᵢRI¹ 721, and the last is wₙᵣᵢ²RIn² 725. Otherwise, the correlation process is the same as in FIG. 7.

Each inquiry made to DSS will have a relevant subset of weights for each vector (signifying the contribution of each particular attribute to each vector space in the correspondence graph (e.g., the size of region R). Furthermore the correlation between two spaces (e.g., between R and M) is influenced by the weight of the correspondence of each pair of vector attributes (e.g., R1, M1) for that particular query. The tables below include the attribute weights and correlation weights for each inquiry. For any weight or coefficient not particularly provided for, its value is set at 0.5, although it may be changed to any value ranging between 0 and 1. The value of the correlation coefficient for the triple overlap space, (CCn in FIG. 8) R-I-M may be the product of the individual correlation coefficients. As an alternative, the correlation coefficient for the R-I-M overlap space (CCn) may be the lowest of any of the three individual correlation coefficients.

Attribute Weight table for Query: “What is the likelihood of obtaining a patent with immediate commercial potential?”

TABLE 40

| Attribute | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| R | .8 | 1 | .6 | .7 | .7 | .8 | .6 | .8 | .8 | .9 | .7 | 1 | .5 | .4 | 1 |
| M | .8 | .9 | .8 | .9 | 1 | .9 | .8 | .7 | .6 | .5 | .4 | | | | |
| I | .9 | .8 | .7 | .7 | .6 | .5 | 1 | .7 | .4 | .9 | 1 | .7 | .6 | | |

R vector Correlation Coefficient Table for I and M regarding Query: “What is the likelihood of obtaining a patent with immediate commercial potential?”

TABLE 41A

| | CCi1, | CCi2, | CCi3, | CCi4, | CCi5, | CCi6, | CCi7, | CCi8, | CCi9, | CCi10, | CCi11, | | |
|---|---|---|---|---|---|---|---|---|---|---|---|---|---|
| Attribute | CCm1 | CCm2 | CCm3 | CCm4 | CCm5 | CCm6 | CCm7 | CCm8 | CCm9 | CCm10 | CCm11 | CCi12 | CCi13 |
| R1 | 1, 1 | .8, 1 | 1, .8 | .8, 1 | .5, 1 | 1, .8 | .5, .6 | .3, .4 | 1, .2 | 1, .1 | .6, .5 | 1 | .7 |
| R2 | 1, 1 | .8, 1 | 1, .8 | .8, 1 | .5, 1 | 1, .8 | .5, .6 | .3, .4 | 1, .2 | 1, .1 | .6, .5 | 1 | .7 |
| R3 | 1, 1 | .8, 1 | 1, .8 | .8, 1 | .5, 1 | 1, .8 | .5, .6 | .3, .4 | 1, .2 | 1, .1 | .6, .5 | 1 | .7 |
| R4 | .8, .8 | .6, .8 | .8, .6 | .6, .8 | .3, .8 | .8, .6 | .3, .4 | .1, .2 | .8, .1 | .8, 0 | .4, .5 | .8 | .5 |
| R5 | .8, .8 | .6, .8 | .8, .6 | .6, .8 | .3, .8 | .8, .6 | .3, .4 | .1, .2 | .8, .1 | .8, 0 | .4, .5 | .8 | .5 |
| R6 | .8, .8 | .6, .8 | .8, .6 | .6, .8 | .3, .8 | .8, .6 | .3, .4 | .1, .2 | .8, .1 | .8, 0 | .4, .5 | .8 | .5 |
| R7 | .8, .8 | .6, .8 | .8, .6 | .6, .8 | .3, .8 | .8, .6 | .3, .4 | .1, .2 | .8, .1 | .8, 0 | .4, .5 | .8 | .5 |
| R8 | .9, .9 | .7, .9 | .9, .7 | .6, .8 | .4, .9 | .9, .7 | .4, .5 | .2, .3 | .9, .1 | .9, 0 | .5, .5 | .9 | .6 |
| R9 | .9, .9 | .7, .9 | .9, .7 | .6, .8 | .4, .9 | .9, .7 | .4, .5 | .2, .3 | .9, .1 | .9, 0 | .5, .5 | .9 | .6 |
| R10 | .9, .9 | .7, .9 | .9, .7 | .6, .8 | .4, .9 | .9, .7 | .4, .5 | .2, .3 | .9, .1 | .9, 0 | .5, .5 | .9 | .6 |
| R11 | .9, .9 | .7, .9 | .9, .7 | .6, .8 | .4, .9 | .9, .7 | .4, .5 | .2, .3 | .9, .1 | .9, 0 | .5, .5 | .9 | .6 |
| R12 | .8, .9 | .6, .9 | .8, .7 | .6, .9 | .3, .9 | .8, .7 | .3, .5 | .1, .3 | .8, .2 | .8, 1 | .4, .5 | .8 | .5 |
| R13 | .8, .9 | .6, .9 | .8, .7 | .6, .9 | .3, .9 | .8, .7 | .3, .5 | .1, .3 | .8, .2 | .8, 1 | .4, .5 | .8 | .5 |
| R14 | .8, .9 | .6, .9 | .8, .7 | .6, .9 | .3, .9 | .8, .7 | .3, .5 | .1, .3 | .8, .2 | .8, 1 | .4, .5 | .8 | .5 |
| R15 | .8, .9 | .6, .9 | .8, .7 | .6, .9 | .3, .9 | .8, .7 | .3, .5 | .1, .3 | .8, .2 | .8, 1 | .4, .5 | .8 | .5 |

I vector Correlation Coefficient Table for M regarding Query: “What is the likelihood of obtaining a patent with immediate commercial potential?”

TABLE 41B

| Attribute | CCm1 | CCm2 | CCm3 | CCm4 | CCm5 | CCm6 | CCm7 | CCm8 | CCm9 | CCm10 | CCm11 |
|---|---|---|---|---|---|---|---|---|---|---|---|
| I1 | 1 | .8 | .8 | .8 | 1 | .8 | .6 | .4 | .2 | .1 | .1 |
| I2 | 1 | .8 | .8 | .8 | 1 | .8 | .6 | .4 | .2 | .1 | .1 |
| I3 | 1 | .8 | .8 | .8 | 1 | .8 | .6 | .4 | .2 | .1 | .1 |
| I4 | .8 | .8 | .6 | .8 | .8 | .6 | .4 | .2 | .1 | .1 | .1 |
| I5 | .8 | .8 | .6 | .8 | .8 | .6 | .4 | .2 | .1 | .1 | .1 |
| I6 | 1 | 1 | 1 | 1 | 1 | 1 | 1 | 1 | 1 | 1 | 1 |
| I7 | .8 | .8 | .6 | .8 | .8 | .6 | .4 | .2 | .1 | .1 | .1 |
| I8 | .9 | .9 | .7 | .8 | .9 | .7 | .5 | .3 | .1 | 0 | .5 |
| I9 | .9 | .9 | .7 | .8 | .9 | .7 | .5 | .3 | .1 | 0 | .5 |
| I10 | .9 | .9 | .7 | .8 | .9 | .7 | .5 | .3 | .1 | 0 | .5 |
| I11 | .9 | .9 | .7 | .8 | .9 | .7 | .5 | .3 | .1 | 0 | .5 |
| I12 | .9 | .9 | .7 | .8 | .9 | .7 | .5 | .3 | .1 | 0 | .5 |
| I13 | .9 | .9 | .7 | .8 | .9 | .7 | .5 | .3 | .1 | 0 | .5 |

Table for Query: “Are present research areas of current relevance, and has the research already been done and protected?”

TABLE 42

| Attribute | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| R | .3 | .3 | .3 | .7 | .7 | .7 | .5 | .9 | .9 | .9 | .7 | 1 | .7 | .7 | .7 |
| M | .7 | .7 | .8 | .5 | .6 | .6 | .6 | .6 | .5 | .5 | .5 | | | | |
| I | .6 | .6 | .9 | .8 | .1 | .2 | .1 | .1 | .8 | .9 | .6 | .9 | .6 | | |

R vector Correlation Coefficient Table for I and M regarding Correlation Coefficient Table for Query: “Are present research areas of current relevance, and has the research already been done and protected?”

TABLE 43A

| | CCi1, | CCi2, | CCi3, | CCi4, | CCi5, | CCi6, | CCi7, | CCi8, | CCi9, | CCi10, | CCi1, | | |
|---|---|---|---|---|---|---|---|---|---|---|---|---|---|
| Attribute | CCm1 | CCm2 | CCm3 | CCm4 | CCm5 | CCm6 | CCm7 | CCm8 | CCm9 | CCm10 | CCm11 | CCi12 | CCi13 |
| R1 | 1, 6 | .8, .5 | 1, .4 | .8, .6 | .5, .4 | 1, .4 | .5, .3 | .3, .2 | 1, .1 | 1, .1 | .6, .5 | 1 | .7 |
| R2 | 1, 6 | .8, .5 | 1, .4 | .8, .6 | .5, .4 | 1, .4 | .5, .3 | .3, .2 | 1, .1 | 1, .1 | .6, .5 | 1 | .7 |
| R3 | 1, 6 | .8, .5 | 1, .4 | .8, .6 | .5, .4 | 1, .4 | .5, .3 | .3, .2 | 1, .1 | 1, .1 | .6, .5 | 1 | .7 |
| R4 | .8, .2 | .6, .2 | .8, .4 | .6, .6 | .3, .6 | .8, .4 | .3, .2 | .1, 0 | .8, 0 | .8, 0 | .4, .5 | .8 | .5 |
| R5 | .8, .2 | .6, .2 | .8, .4 | .6, .6 | .3, .6 | .8, .4 | .3, .2 | .1, 0 | .8, 0 | .8, 0 | .4, 5 | .8 | .5 |
| R6 | .8, .2 | .6, .2 | .8, .4 | .6, .6 | .3, .6 | .8, .4 | .3, .2 | .1, 0 | .8, 0 | .8, 0 | .4, .5 | .8 | .5 |
| R7 | .8, .2 | .6, .2 | .8, .4 | .6, .6 | .3, .6 | .8, .4 | .3, .2 | .1, 0 | .8, 0 | .8, 0 | .4, .5 | .8 | .5 |
| R8 | .9, .2 | .7, .2 | .9, .5 | .6, .6 | .4, .7 | .9, .5 | .4, .3 | .2, .1 | .9, 0 | .9, 0 | .5, .5 | .9 | .6 |
| R9 | .9, .2 | .7, .2 | .9, .5 | .6, .6 | .4, .7 | .9, .5 | .4, .3 | .2, .1 | .9, 0 | .9, 0 | .5, .5 | .9 | .6 |
| R10 | .9, .2 | .7, .2 | .9, .5 | .6, .6 | .4, .7 | .9, .5 | .4, .3 | .2, .1 | .9, 0 | .9, 0 | .5, .5 | .9 | .6 |
| R11 | .9, .2 | .7, .2 | .9, .5 | .6, .6 | .4, .7 | .9, .5 | .4, .3 | .2, .1 | .9, 0 | .9, 0 | .5, .5 | .9 | .6 |
| R12 | 1, .7 | .6, .7 | .7, .6 | .5, .5 | .3, .6 | .7, .6 | .3, .5 | .1, .3 | .8, .2 | .8, 1 | .4, .5 | .8 | .5 |
| R13 | 1, .7 | .6, .7 | .7, .6 | .5, .5 | .3, .6 | .7, .6 | .3, .5 | .1, .3 | .8, .2 | .8, 1 | .4, .5 | .8 | .5 |
| R14 | 1, .7 | .6, .7 | .7, .6 | .5, .5 | .3, .6 | .7, .6 | .3, .5 | .1, .3 | .8, .2 | .8, 1 | .4, .5 | .8 | .5 |
| R15 | 1, .7 | .6, .7 | .7, .6 | .5, .5 | .3, .6 | .7, .6 | .3, .5 | .1, .3 | .8, .2 | .8, 1 | .4, .5 | .8 | .5 |

I vector Correlation Coefficient Table for M regarding Query: “Are present research areas of current relevance, and has the research already been done and protected?”

TABLE 43B

| Attribute | CCm1 | CCm2 | CCm3 | CCm4 | CCm5 | CCm6 | CCm7 | CCm8 | CCm9 | CCm10 | CCm11 |
|---|---|---|---|---|---|---|---|---|---|---|---|
| I1 | 1 | .8 | .8 | .8 | 1 | .8 | .6 | .4 | .2 | .1 | .1 |
| I2 | 1 | .8 | .8 | .8 | 1 | .8 | .6 | .4 | .2 | .1 | .1 |
| I3 | 1 | .8 | .8 | .8 | 1 | .8 | .6 | .4 | .2 | .1 | .1 |
| I4 | .8 | .8 | .6 | .8 | .8 | .6 | .4 | .2 | .1 | .1 | .1 |
| I5 | .8 | .8 | .6 | .8 | .8 | .6 | .4 | .2 | .1 | .1 | .1 |
| I6 | 1 | 1 | 1 | 1 | 1 | 1 | 1 | 1 | 1 | 1 | 1 |
| I7 | .8 | .8 | .6 | .8 | .8 | .6 | .4 | .2 | .1 | .1 | .1 |
| I8 | .9 | .9 | .7 | .8 | .9 | .7 | .5 | .3 | .1 | 0 | .5 |
| I9 | .9 | .9 | .7 | .8 | .9 | .7 | .5 | .3 | .1 | 0 | .5 |
| I10 | .9 | .9 | .7 | .8 | .9 | .7 | .5 | .3 | .1 | 0 | .5 |
| I11 | .9 | .9 | .7 | .8 | .9 | .7 | .5 | .3 | .1 | 0 | .5 |
| I12 | .9 | .9 | .7 | .8 | .9 | .7 | .5 | .3 | .1 | 0 | .5 |
| I13 | .9 | .9 | .7 | .8 | .9 | .7 | .5 | .3 | .1 | 0 | .5 |

Table for Query: “Are there research areas in which the institution have strengths and should consolidate or focus on?” This is an example query where an additional attribute for the R vector is added to address the particular query. Thus an additional attribute 331 (FIG. 3) is added to include # of similar research projects, having values of 0 for 0 similar research projects, 0.25 for 2 similar projects, 0.5 for 3 similar projects, 0.75 for 4 similar projects, and 1 for 5 or more similar projects. Thus, a new attribute R16 is added for accommodate this additional attribute 331 in the tables below.

TABLE 44

| Attribute | 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|---|
| R | .3 | .3 | .3 | .7 | .7 | .7 | .5 | .9 | .9 | .9 | .7 | 1 | .7 | .7 | .7 | 1 |
| M | .7 | .7 | .8 | .5 | .6 | .6 | .6 | .6 | .5 | .5 | .5 | | | | | |
| I | .6 | .6 | .9 | .8 | .1 | .2 | .1 | .1 | .8 | .9 | .6 | .9 | .6 | | | |

Correlation Coefficient Table for Query: “Are there research areas in which the institution have strengths and should consolidate or focus on?”

TABLE 45A

| | CCi1, | CCi2, | CCi3, | CCi4, | CCi5, | CCi6, | CCi7, | CCi8, | CCi9, | CCi10, | CCi11 | | |
|---|---|---|---|---|---|---|---|---|---|---|---|---|---|
| Attribute | CCm1 | CCm2 | CCm3 | CCm4 | CCm5 | CCm6 | CCm7 | CCm8 | CCm9 | CCm10 | CCm11 | CCi12 | CCi13 |
| R1 | 1, 6 | .8, .5 | 1, .4 | .8, .6 | .5, .4 | 1, .4 | .5, .3 | .3, .2 | 1, .1 | 1, .1 | .6 | 1 | .7 |
| R2 | 1, 6 | .8, .5 | 1, .4 | .8, .6 | .5, .4 | 1, .4 | .5, .3 | .3, .2 | 1, .1 | 1, .1 | .6 | 1 | .7 |
| R3 | 1, 6 | .8, .5 | 1, .4 | .8, .6 | .5, .4 | 1, .4 | .5, .3 | .3, .2 | 1, .1 | 1, .1 | .6 | 1 | .7 |
| R4 | .8, .2 | .6, .2 | .8, .4 | .6, .6 | .3, .6 | .8, .4 | .3, .2 | .1, 0 | .8, 0 | .8, 0 | .4 | .8 | .5 |
| R5 | .8, .2 | .6, .2 | .8, .4 | .6, .6 | .3, .6 | .8, .4 | .3, .2 | .1, 0 | .8, 0 | .8, 0 | .4 | .8 | .5 |
| R6 | .8, .2 | .6, .2 | .8, .4 | .6, .6 | .3, .6 | .8, .4 | .3, .2 | .1, 0 | .8, 0 | .8, 0 | .4 | .8 | .5 |
| R7 | .8, .2 | .6, .2 | .8, .4 | .6, .6 | .3, .6 | .8, .4 | .3, .2 | .1, 0 | .8, 0 | .8, 0 | .4 | .8 | .5 |
| R8 | .9, .2 | .7, .2 | .9, .5 | .6, .6 | .4, .7 | .9, .5 | .4, .3 | .2, .1 | .9, 0 | .9, 0 | .5 | .9 | .6 |
| R9 | .9, .2 | .7, .2 | .9, .5 | .6, .6 | .4, .7 | .9, .5 | .4, .3 | .2, .1 | .9, 0 | .9, 0 | .5 | .9 | .6 |
| R10 | .9, .2 | .7, .2 | .9, .5 | .6, .6 | .4, .7 | .9, .5 | .4, .3 | .2, .1 | .9, 0 | .9, 0 | .5 | .9 | .6 |
| R11 | .9, .2 | .7, .2 | .9, .5 | .6, .6 | .4, .7 | .9, .5 | .4, .3 | .2, .1 | .9, 0 | .9, 0 | .5 | .9 | .6 |
| R12 | 1, .7 | .6, .7 | .7, .6 | .5, .5 | .3, .6 | .7, .6 | .3, .5 | .1, .3 | .8, .2 | .8, 1 | .4 | .8 | .5 |
| R13 | 1, .7 | .6, .7 | .7, .6 | .5, .5 | .3, .6 | .7, .6 | .3, .5 | .1, .3 | .8, .2 | .8, 1 | .4 | .8 | .5 |
| R14 | 1, .7 | .6, .7 | .7, .6 | .5, .5 | .3, .6 | .7, .6 | .3, .5 | .1, .3 | .8, .2 | .8, 1 | .4 | .8 | .5 |
| R15 | 1, .7 | .6, .7 | .7, .6 | .5, .5 | .3, .6 | .7, .6 | .3, .5 | .1, .3 | .8, .2 | .8, 1 | .4 | .8 | .5 |
| R16 | 1, .1 | 1, 1 | 1, 1 | 1, 1 | 1, 1 | 1, 1 | 1, 1 | 1, 1 | 1, 1 | 1, 1 | 1 | 1 | 1 |

I vector Correlation Coefficient Table for M regarding Query: “Are there research areas in which the institution have strengths and should consolidate or focus on?”

TABLE 45B

| Attribute | CCm1 | CCm2 | CCm3 | CCm4 | CCm5 | CCm6 | CCm7 | CCm8 | CCm9 | CCm10 | CCm11 |
|---|---|---|---|---|---|---|---|---|---|---|---|
| I1 | 1 | .8 | .8 | .8 | 1 | .8 | .6 | .4 | .2 | .1 | .1 |
| I2 | 1 | .8 | .8 | .8 | 1 | .8 | .6 | .4 | .2 | .1 | .1 |
| I3 | 1 | .8 | .8 | .8 | 1 | .8 | .6 | .4 | .2 | .1 | .1 |
| I4 | .8 | .8 | .6 | .8 | .8 | .6 | .4 | .2 | .1 | .1 | .1 |
| I5 | .8 | .8 | .6 | .8 | .8 | .6 | .4 | .2 | .1 | .1 | .1 |
| I6 | 1 | 1 | 1 | 1 | 1 | 1 | 1 | 1 | 1 | 1 | 1 |
| I7 | .8 | .8 | .6 | .8 | .8 | .6 | .4 | .2 | .1 | .1 | .1 |
| I8 | .9 | .9 | .7 | .8 | .9 | .7 | .5 | .3 | .1 | 0 | .5 |
| I9 | .9 | .9 | .7 | .8 | .9 | .7 | .5 | .3 | .1 | 0 | .5 |
| I10 | .9 | .9 | .7 | .8 | .9 | .7 | .5 | .3 | .1 | 0 | .5 |
| I11 | .9 | .9 | .7 | .8 | .9 | .7 | .5 | .3 | .1 | 0 | .5 |
| I12 | .9 | .9 | .7 | .8 | .9 | .7 | .5 | .3 | .1 | 0 | .5 |
| I13 | .9 | .9 | .7 | .8 | .9 | .7 | .5 | .3 | .1 | 0 | .5 |

This process of identifying attributes, weights and correlation coefficients may be applied to other R-I-M correspondence space analyses for other queries. For example the weights of Table 42 and coefficients of Tables 43A and 43B may be used for the query “For which application areas are particular technology/invention typically used?” However, an additional I attribute I14 would be added having values of 0 for no particular focus technology, and 1 if there is particular patent strategy focus area identified, a weight of 1 and coefficients of 1 each for R and M.

Similar weight and coefficient tables are stored for queries (a) What are the overall trends in patenting in a particular sector over time, territory and application areas?; (b) Which fields are being exploited by which organizations?; (c) How does the institution's invention disclosure compare with current patents and applications?; (d) Where does the institution's patent portfolio sit in the overall landscape—does it form a distinct well-protected area, or is it a single patent surrounded by a thicket of competitors?; (e) Which existing patents may be relevant for freedom to operate and for patentability? i.e., has a freedom to operate been obtained; (f) Where are the whitespace gaps and opportunities to direct our research activities? The tables used above may optionally be used for these queries.

FIG. 9 is a flowchart of a process for determining the overlap amounts for the different component vectors in R-I-M space. The process begins in step S80 where each of the vector attributes has a weight applied thereto. The weights are stored in a memory table and are predetermined for the particular research area. The process then proceeds to step S82 where pairs of weighted adjacent attributes are multiplied with each other, and then in S84 the products of all the multiplications are accumulated. Then in step S86 a query is made regarding whether all the pairs of attributes have been multiplied. If the response to the query is negative, the process proceeds to step S88 where the attributes in one vector are circular shifted and the process then returns to step S82. However, if the response to the query in Step S86 is affirmative, the process proceeds to S90, where the cumulative output is produced and used for graphical analysis. The value that is output is fraction of the total area that would materialize if the max weight is applied to the max value of all attributes for all vectors and the correlation is performed on that maximum condition. Moreover, the output that is produce in S90 can be a percentage of the maximum possible overlap space for the component vectors in R-I-M space.

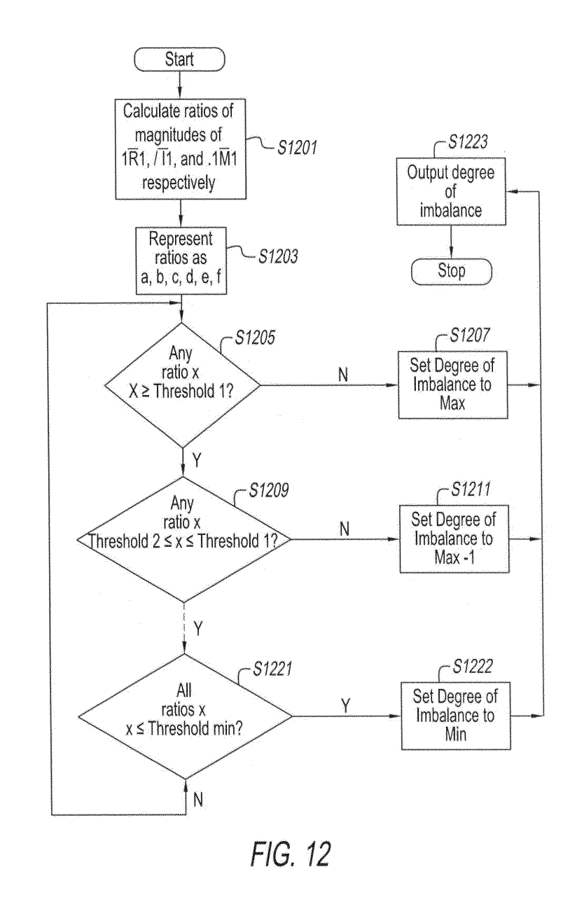

FIG. 10 is a block diagram of the vector imbalance processor 203. The imbalance processor 203 includes an interface 1007 that exchanges data amongst the internal components and external devices. Internally, data is shared on a bus 1009. The vector imbalance processor includes a ratio of component vector processor 1001 that calculates the overlap regions with respect to the total area of the R, I and M spaces respectively. For example, the R-I overlap space is certain percentage of the R area and of the same or different percentage of the I area. The ratios of component vector processor 1001 also identifies the magnitudes of the projections of a project-vector onto the R axis, the M axis and the I axis. Once the magnitudes are determined, the relative ratios of the magnitudes of each of the different vectors are determined. For example, the first ratio is determined from the magnitude of R divided by the magnitude of M. This is characterized by | R̅|/| M̅|=a. Other ratios are calculated as well, such as | M̅|/|Ī|=b. Also, |Ī|/| R̅|=c. Likewise, | R̅|/|Ī|=d. | M̅|/| R̅|=e. |Ī|/| M̅|=f. By comparing each of the magnitudes of the vectors relative to one another allows for a statistical analysis to be begun if the different ratios are near a same value (suggesting balance), or have substantially different values (suggesting imbalance). This analytical process is done by the statistical processor 1003, where comparisons are made between the magnitudes and predetermined thresholds as will be discussed with regard to FIG. 12.

The imbalance determination processor 1005 takes the results of the statistical processor 1003 to determine the magnitude of the imbalance and the amount of imbalance as it relates to either the R, the M or the I component.

FIG. 11 is directed to a block diagram of a radial length generator 205. A bus 111 interconnects an interface 1109 with other internal components. Among other things, the radial length generator includes a vector magnitude processor 1101 that determines the magnitudes of the constituent components R̅, M̅ and Ī. The radial length generator 1103 then sums the magnitudes in order to determine an overall radial length, in combination with a radial length calculator 1105. A commercial value projection processor 1107 calculates the relative size of the radial length for the project relative to the entire vector population in the R-I-M space. The larger relative size of the radial length of the subject vector is an indication of an increased commercial value because more “market relevant” attributes are associated with that vector than other projects.

FIG. 12 is a flowchart showing a process for determining a degree of imbalance as determined by the vector imbalance processor 203 (FIG. 10). The process begins in step 1201, where the vector imbalance processor 203 calculates ratios of the magnitudes of R̅, I̅ and M̅, respectively. The process then proceeds to step S1203, where the different ratios (e.g., | R̅|/| M̅|=a), where each of the other ratios as previously discussed is represented by b-f. The process then proceeds to step S1205, where a query is made regarding whether any of the ratios (a-f), represented by x, are greater than or equal to a predetermined threshold. In one example the threshold is 2 (or its reciprocal ½), although another threshold may be used depending on the sensitivity of the imbalance that is to be detected. Thus ratios of 5, 4, or 3 may be used, as well as their reciprocals ⅕, ¼, or ⅓ (as well as any value there between) may be used as well.

If the response to the query in step S1205 is negative, the degree of imbalance is set to be a maximum in step S1207. However, if the response to the inquiry in step S1205 is affirmative, the process proceeds to step S1209, where another query is made regarding whether any of the ratios are between the first threshold and the second threshold. If the response to the query is negative, the process proceeds to step S1211, where the degree of imbalance is set to max −1. However, if the process is affirmative, the process proceeds to one or more steps where additional ratios are determined relative to the thresholds. The last query is shown in step S1221, where a query is made regarding whether the ratio is less than the minimum threshold. If the response to the inquiry is yes, the process proceeds to step S1222 where the degree of imbalance is set to minimum. On the other hand, if the response is negative the process proceeds to step S1205 where the process repeats to characterize the ratios again. The output of steps S1207, S1211 and S1222 all proceed to step S1223, where the degree of imbalance has determined its output as a quantity. Subsequently the process ends.

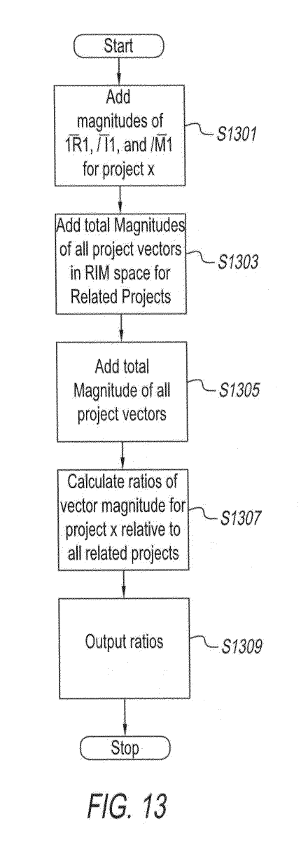

FIG. 13 is a flowchart showing a process for determining the output ratios of the vector magnitude for a particular project. The process begins in step S1301, where all the magnitudes for a particular project are identified for R̅, Ī and M̅. The process then proceeds to step S1303, where all the magnitudes are added in the R-I-M space for related projects. Subsequently the process proceeds to step S1305 where total magnitudes are added for all the project-vectors. Subsequently the process proceeds to step S1307, where the ratios are calculated of vector magnitude for project X relative to all related projects and then the ratios are output in step S1309. Subsequently the process terminates.

FIG. 14 is a block diagram of the vector database 207. The database holds internally a model vector database for different projects including magnitude in component 1401. Likewise, model vector database for different projects, including an imbalance amount, is held in 1402. For both elements 1401 and 1402, the term “model” means predetermined imbalance shapes and magnitudes for particular projects. These are used for comparison purposes to determine imbalance and expected magnitudes of project-vectors. Element 1403 holds thresholds, as were previously discussed, and element 1404 includes predetermined commercialization values for different percentage of vector lengths. Moreover, as was previously discussed, for longer vector lengths, higher commercialization values are associated therewith. The vector database 207 also includes element 1407 which includes a database of spider and correspondence graph shapes used for comparison purposes with observed spider graphs and correspondence graphs for a particular project. All the components intercommunicate with a bus 1406 and communicate externally via an interface 1405.

FIG. 15A is a spider graph of a R component vector, which illustrates an imbalance of inputs for 4 attributes as shown by the lengths of the polygon 1501 not being equi-length. This is contrasted with a more balanced set of attributes for a R component vector in FIG. 15B, which shows nearly equi-length segments of the polygon 1503. The spider graphs may be generated as well for higher numbers of attributes to show imbalances between different constituent attributes that make up the R vector. Having a better balanced R component vector will result in possible imbalances in correspondence regions between R, I, M vectors in the R-I-M space. Similar spider graphs may be generated for the actual and ideal I component vectors and M component vectors to illustrate imbalances within component vectors.

FIG. 16 is a flowchart of a process for producing a spider graph (or a radar graph). The process begins in step S1600, where a spreadsheet of vector magnitude values for R, I and M as well as one for attribute values is created. The process then proceeds to step S1601, where the radar graph option (such as in EXCEL) is executed on the spreadsheet, and the resulting chart is saved in memory. Separate charts may be made for R, I and M, or they may be graphed on a common graph. Subsequently the chart(s) are output to a display for presentation as part of a Graphical User Interface. The user may then manipulate the chart to improve the symmetry, and a change in vector values is observed to correspond with the change in the chart. The change in vector value may be used to see how much of a change is needed in vector magnitude or attribute value to obtain the desired symmetry.

FIG. 17 is a block diagram of a static imbalance processor 210. The static imbalance processor 210 includes a bus 1711 that interconnects an interface 1701 with other internal components. A normalization processor 1703 receives an input for each of the constituent components R-I-M for the project-vector and normalizes the size so as to be compared with predetermined stored shapes stored in vector database 207. An overlap analyzer 1705 performs an overlap analysis, determining the amount of area between the project-vector space for each of the constituent components, relative to predetermined database values. The output of the overlap analyzer 1705 is provided to a spatial imbalance determination processor 1707, which identifies if there is a lopsided nature to the target vector in either the I, M or R space such that the project-vector is indicated as being imbalanced in at least one of the R-I-M domains. An output of the spatial imbalance determination processor 1707 is provided to the vector adjustment processor 1709, which identifies what changes could be made to the target project-vector in order to make it within a predetermined tolerance of a shape or overlap of the other constituent components.

FIG. 18 is a flowchart describing the process performed by the static imbalance processor 210 of FIG. 17. The process begins in step S1701, where an input correspondence graph is provided for project x. The correspondence graph would be partially overlapping R regions, M regions and I regions. The process then proceeds to step S1703, where the correspondence graphs are compared with the prestored correspondence graph from the database. Then a normalization process is performed in step S1705 so that the relative sizes of the prestored correspondence graph and the input correspondence graph have common areas. Then the process proceeds to step S1707, where overlaps are identified between the different regions, namely R-I, R-M, I-M, and R-I-M. Then, in step S1709, an amount of imbalance is identified for the different overlapping areas. This imbalance is identified on a correspondence area basis, namely when an observed area is of a different size by a predetermined amount relative to the prestored area. In step S1711, the different factors in each dimension that are available for adjustment in order to adjust to stay within a predetermined tolerance of balance are identified. These factors are then output as recommendations to the graphical user interface display 105 in step S1713.

Furthermore, the static imbalance processor 210 provides an output result that shows the relative overlaps in regions 25, 27, 29 and 31 in FIGS. 1B, 1C, 1D, and 1E respectively. These relative overlap amounts may then be compared to pre-stored values that range from a minimum to a maximum (e.g. a score of 1 to 10). The prestored values are associated with a response to a query made on the user. For example the query may be to estimate whether the present research project x is likely to produce a commercially valuable patent. If the overlap score is 10, then it is highly likely. However, if the overlap score is 1, then it unlikely. Each potential query will have a different set of attributes that are included in the respective component vectors.

FIG. 19 is a block diagram of the temporal imbalance processor 213. Internal components of the temporal imbalance processor 213 are interconnected by a bus 1809 and provide external communication by way of interface 1801. A historical change processor 1803 keeps track of different imbalance results made as a function of time. The historical change processor 1803 can then provide as output via the interface 1801 a series of different static imbalances taken at different times. Moreover, in response to a particular query playing a historical recreation of the static imbalances over, for example a two-year period, the historical change processor 1803 provides a set of static imbalance processors over that period of time so that changes may be identified graphically and observed by an end user through a graphical user interface. The projected change processor 1805 instead of looking backwards, as is the case with the historical change processor 1803, makes projections based on observed historical changes so as to project into the future how the changes would continue to affect the overlaps and correspondence in the R-I-M space if the changes continue at a same pace.

The graphics generator 1807 presents the historical changes and projected changes in a graphical form and outputs the same on the GUI display 105 (FIG. 1).

FIG. 20 is a flowchart of the temporal imbalance processor functions and the process begins in step S2000, where a request is received for a temporal imbalance analysis for a predetermined time period, t. The process then proceeds to step S2001 where historical data is retrieved and then in step S2003, a graph is created and output for the historical data for the time period requested. Then the process proceeds to step S2005, where a query is made if a forward-looking projection is requested. If the response to the query in step S2005 is negative, the process stops. On the other hand, if the response to the query in step S2005 is affirmative, the process proceeds to step S2007 where an estimate for a future shape of the correspondence graph based on the observed rate of change is made. Subsequently in step S2009 the output of the projected estimated shape as a function of time is provided for the predetermined time period.

FIG. 21 is a block diagram of a project feedback processor 215. The project feedback processor 215 communicates with an internal bus 2109 and communicates externally with an interface 2101. A project milestone and event tracker 2103 keeps track of different reporting times as well as identifies when particular events occur that may compel a project report. A compliance tracker 2105 compares the static imbalance output with a compliance requirement to determine whether compliance is achieved, and then a report of the compliance or non-compliance is generated in report generator 2107.

FIG. 22 is a flowchart of the process performed by the project feedback processor 215. The process starts in step S2200 where project milestones are retrieved from memory or from an external device. Then an inquiry is made in step S2201 regarding whether a new event has occurred. If the response to the inquiry in step S2201 is negative the process returns to the start of the process. However, if a new event was detected, the process proceeds to step S2203 where a comparison is made of the vector radial length of the project-vector with a predetermined value. Subsequently the process proceeds to the query in step S2205, where the query is whether the radial length is within 10% of the projection. Although 10% is used for example, the 10% compliance metrics need not be so restricted and can vary between 1% and 50%, depending on the threshold that is set. If the response to the query in step S2205 is affirmative, the process proceeds to step S2207 and a report is generated that the project is on target and subsequently the process ends. However, if the response to the query in step S2205 is negative, in step S2209 the vector components are identified that are farthest from compliance. Subsequently a report is generated identifying the most noncompliant components in step S2211. Subsequently the process ends.

FIG. 23 is a block diagram of commercialization scorecard processor 217. The commercialization scorecard processor 217 uses bus 2307 for internal communications and an interface 2301 for external communications. A commercialization prediction processor 2303 obtains different factors as will be discussed in FIG. 24 in order to provide weighting functions to the different factors and make a prediction of the commercialization success for the target project. The results of the commercialization prediction processor are provided to the commercialization scorecard generator 2305 that generate a scorecard of different attributes as will be discussed. A regional analyzer 2309 provides a geographic restricted commercialization scorecard if the target project is limited to a particular geographic area.

The process for generating a commercialization scorecard is shown in FIG. 24. Step S2401 begins by obtaining an IP assessment from the IP review processor 219 (FIG. 2). It also identifies whether prototype has been performed for the subject research or innovation project, collects target information regarding whether there is a target candidate for the innovation process and IP, funding sources, radial vector length, funding vehicles for commercialization, and target lists for joint ventures. The process then proceeds to step S2403, where weighting factors are retrieved from memory for each of the different characteristics identified in step S2401. In step S2405, the weighted factors are combined to produce a scorecard and an ultimate score. The IP assessment includes a review to identify, number of patents/applications by assignee, number of patents/applications by others in a common subclass as a subject patent/application; number of times the patent/application was cited by others or examiners; number of amendments; number of lines in broadest claim; number and type of rejection; number of keywords in broadest claim; whether one or more continuation-type application is pending, whether the application has been proofed for being challenged in Inter Partes Review; whether a pre-license review has been done to at least meet Rule 11 standards; whether any problems have been identified and corrected prior to be asserted in licensing or litigation; whether a whitespace analysis has been performed etc. Results of the analysis may be presented on the scorecard alongside scenario-dependent standards for each criterion so the user can quickly observe deviations between the actual data and the scenario-dependent standards.

The process then proceeds to step S2407, where a query is made regarding whether a region input was made. If no, the process ends. However, if the response to the query in step S2407 is affirmative, the process proceeds to step S2409, where the factors are limited to within the range that was input. This is one example of how micro, meso and micro queries may be used to set the scope of a query. Then, in step S2411, the combined weighted factors for that region are used to produce the regional score and scorecard.

FIG. 25 is a block diagram of the IP review processor 219 the hardware for such may be implemented with the hardware of FIG. 34. An internal bus 2515 interconnects the internal components, and an interface 2501 provides external communications. A claim analyzer 2503 provides an objective analysis of the claims in the IP, as will be discussed with regard to FIG. 26. A regional analyzer 2505 determines whether the scope of the IP sought, or being sought, covers the region of interest (e.g., macro, meso or micro) for the market in which the target data has been collected. A patent family analyzer 2507 determines whether the IP that represents the innovation is one of a group of IP assets, and if so whether a pending application remains. This is because a pending application may be most valuable when licensing, as some flexibility in the claims to cover the target product are available. A validity predictive processor 2509 provides a validity assessment of the IP to make an estimation regarding whether the patent may be enforceable or not for supporting a joint venture, license, or other commercialization endeavor. The IP target analyzer 2511 compares the scope of the pending claims with the targets that have been identified in the market database, as will be discussed. A patent citation analyzer 2513 identifies whether the subject patent includes a number of citations from competitors in the market database, indicating that other market competitors may have innovations in the same space. Also, the patent citation analyzer 2513 identifies the number of citations made by an Examiner in other people's patents, indicating that the subject patent/application is relevant to third parties' patents and/or applications.

FIG. 26 is a process flow for the IP review processor 219. The process begins in step S2601, where the information is retrieved regarding the patents, family information from a PTO, target information, supplemental information and regional information. The process then proceeds to step S2602, where a query is made regarding whether the number of members in a family are greater than a predetermined threshold. If the response to the inquiry in step S2602 is affirmative, a counter is incremented by the size of the family (or some other factor indicating that it is favorable to have multiple family members) in step S2603. Subsequently the process proceeds to the query in step S2605, where a query is made regarding whether a continuation application is pending. If the response to the query in step S2605 is affirmative the process proceeds to step S2607, where the index is incremented by a predetermined factor S. The process then proceeds to step S2609 where another inquiry is made regarding the number of lines in the broadest claims being less than or equal to Z. If the response to the inquiry in S2609 is affirmative the process proceeds to step S2611, where the index is incremented by W, where W is a predetermined number that is larger for a smaller number of lines. This is because as a general matter, the smaller the number of claims in a line, the broader it is. The process then proceeds to the query in step S2613, regarding whether the number of citations is greater than or equal to Q. If the response to the query in step S2613 is affirmative, then the index is incremented by T and the process proceeds to step S2617. In step S2617, a query is made regarding the number of Examiner citations being greater than N. If the response to the query in step S2617 is affirmative, then the index is incremented by P, another factor indicating that the greater number of citations made by the Examiner in other people's patents means that the present application is of greater relevance to third parties. This increment is made in step S2619, and then the process is continued to step S2621, where a query is made regarding licensing. If the patent asset has already been licensed, the process proceeds to step S2623, where the index is incremented indicating that an already licensed patent is one that in all likelihood has been challenged and is therefore stronger. The process then proceeds to step S2625, where a query is made regarding whether the patent claims fall within a targeted area. If the response to the query in step S2625 is affirmative, then the index is incremented by another threshold B in step S2627 and then the process proceeds to step S2629. In step S2629, an inquiry is made regarding whether the patent has survived an inter parties review, litigation, or opposition challenge. If the response to the query in step S2629 is affirmative, then the index is incremented by a value D in step S2631, and subsequently the process proceeds to step S2633, where the value of the index is output to the bus 223 (FIG. 2). Subsequently the process stops.

FIG. 27 is a block diagram of the commercialization scorer 221, which includes an internal bus 2707 that interconnects an interface 2701 of the commercialization scorer 2703 and a lookup table 2705. The commercialization scorer, as will be discussed with regard to FIG. 28, combines the imbalance results with the IP review results and commercialization scorecard to identify a commercialization scorer. The commercialization scorer associates the combined factors input thereto from a lookup table 2705, which has corresponding scorers for different IP index values, commercialization scorecard values, as will be discussed.

FIG. 28 is a flowchart of a process flow performed by the commercialization scorer 221. The process begins in step S2801, where the IP value is retrieved. The process then continues to step S203, where the commercialization scorecard is received and then the IP value and the commercialization scorecard value are combined in step S2805. The process then proceeds to step S207, where the combined score is associated with a lookup table value in order to identify a match and an output commercialization score to be reported.

FIG. 29 is an exemplary graphical user interface display 105 having nine different sections. Section 105a provides a graphic of the RMI space. It also describes the total RMI space 105b with different project-vectors X, Y, Z, Q. The GUI display 105 also includes spider graphs for each of the different constituent components in 105c. A static imbalance display 105d includes not only a graphic of the overlap between the research, innovation and market components of the project space, but also includes a relative overlap percentage between R-I, R-M and I-M. Each of these different percentages are then compared to a threshold to determine if any of the thresholds are not within a predetermined threshold, indicating noncompliance or having a particular imbalance. In 105d, the R-M overlap is greater than the predetermined threshold, indicating there is an imbalance between the R and the M. Graphic partition 105e shows temporal imbalance shown for a function of time, two years for example, broken up into six month increments. Included in the temporal imbalance display 105e is an indication whether a change is recommended to encourage a dilution of the amount of imbalance experienced by influencing the research or innovation aspects of the project. GUI display 105 includes a partition 105f that shows a projected overlap looking forward into the future. This can be broken up into certain predetermined time increments, shown in six month increments for example. Also shown is the recommended changes in order to produce a particular desired result in the future.

A radial length comparison display 105g is shown, showing that the particular project is a certain percentage of a total project space as shown. A commercialization scorecard is shown in display element 105h and in display element 105i a commercialization scorecard for a region is shown.

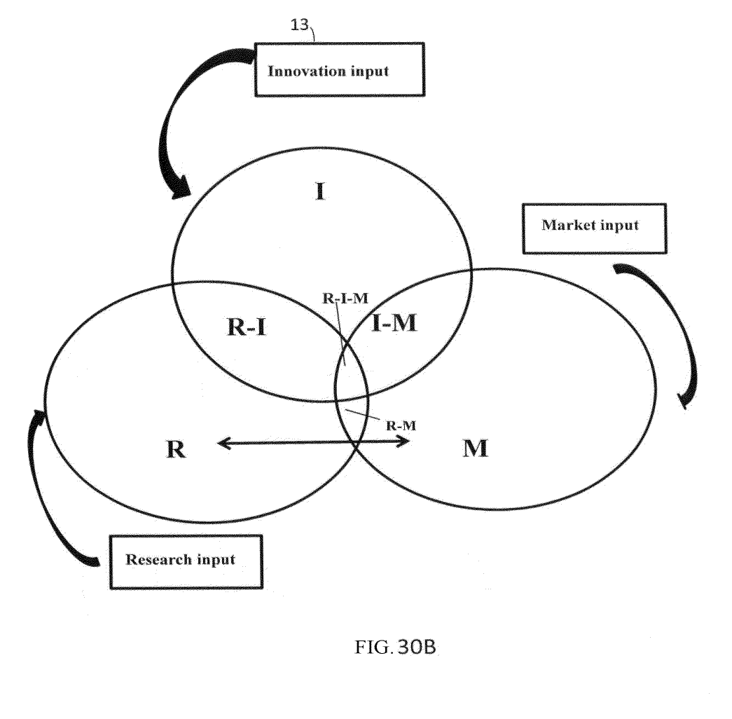

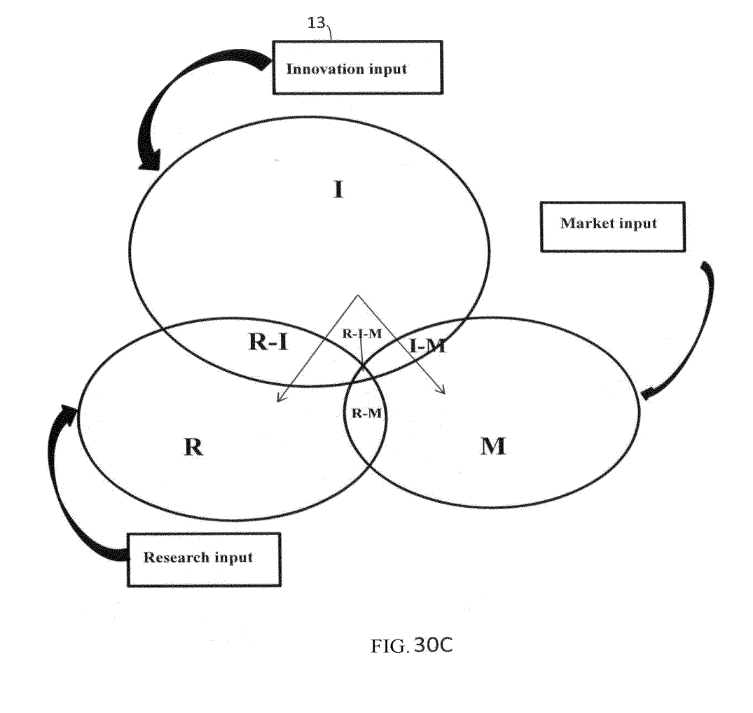

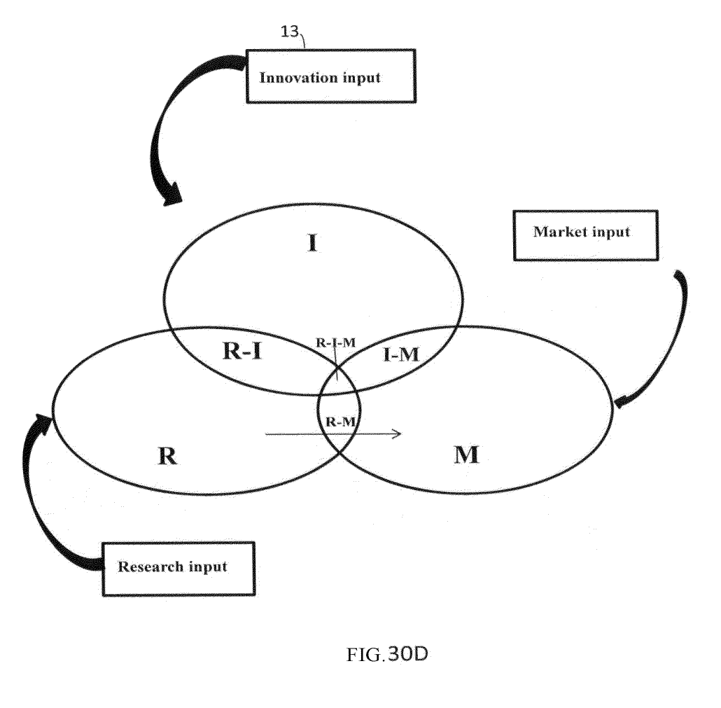

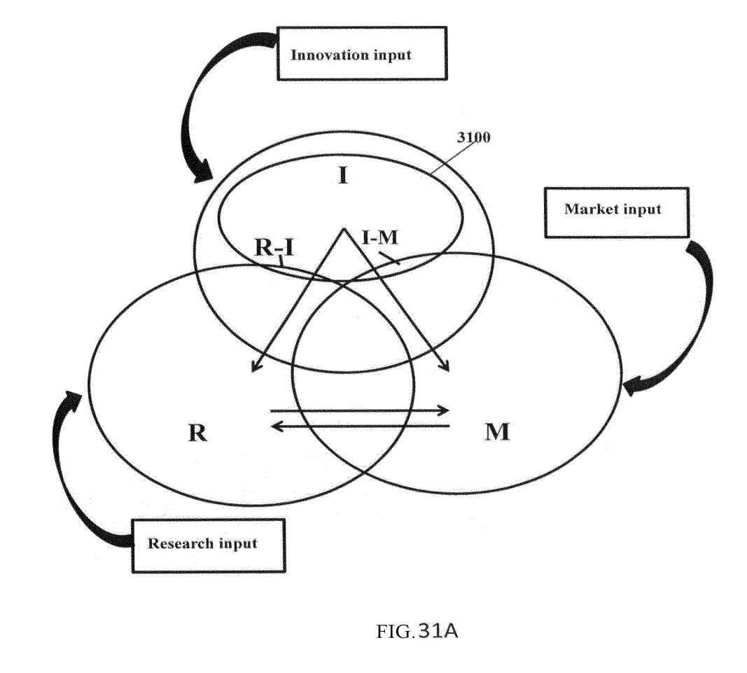

FIG. 30A is an exemplary correspondence graph that shows a substantial R-I-M overlap area, with a well-balanced shape. This type of overlap area suggest that the research, innovation, and market components are well balanced, which in turn provides a relatively high likelihood of producing IP with a high commercial potential and sustainable scalable innovation generation during the project life.

FIG. 30B is another exemplary correspondence graph that shows a smaller R-I-M overlap area than FIG. 30A, with a skewed shape that has little R and M overlap. This type of overlap area suggests that more market input into research is required to improve the R-I-M overlap region. This recommended adjustment would improve the likelihood of producing IP with a high commercial potential and sustainable scalable innovation generation during the project life. Moreover, to enable the transformation from the region in FIG. 30 to FIG. 30A, the following are suggested: (1) Increased market input (i.e. shift circle M to the left) and/or; (2) Increased research or innovation resource. It is noteworthy that the input and resource are different in the current context: in this context input means knowledge and resource means financial and human resources.

Therefore in the example of FIG. 30B the following is desired:
More knowledge from the market place e.g. more market input to enable the research to lead to more innovation—(consultancy input)
More research resource (human resource)—research capability in terms of people with the required technical skills
More research resource (financial resource)—in terms of infrastructure to carry out the research.
More innovation resource—more access to expertise e.g. innovation management—innovation landscapes & innovation freedom to operate, innovation assessment: (consultancy input)

FIG. 30C is another exemplary correspondence graph that shows a smaller R-I-M overlap area than FIG. 30A, with a skewed shape that has little I overlap. This type of overlap area suggests that more innovation input into research is required to improve the R-I-M overlap region. This recommended adjustment would improve the likelihood of producing IP with a high commercial potential and sustainable scalable innovation generation during the project life.

FIG. 30D is another exemplary correspondence graph that shows a smaller R-I-M overlap area than FIG. 30A, with a skewed shape that has little I and M overlap with R. This type of overlap area suggests that more market input into research is required and more innovation input into research is required to improve the R-I-M overlap region. This recommended adjustment would improve the likelihood of producing IP with a high commercial potential and sustainable scalable innovation generation during the project life.

Table 1 below provides a summary explanation for how to respond to other scenarios.

TABLE 1

| | Requirements for | Required functions for |
|---|---|---|
| | transformation to | transformation to Scenario |
| | Scenario shown in Figure | shown in FIG. 30A, i.e. |
| Scenario | 30A, i.e. ideal scenario | ideal scenario |
| FIG. 30B | Increased market input | More market knowledge (M) |
| | Increased research and | consultancy |
| | innovation resources | More technical skills (R) |
| | | More entrepreneurial |
| | | skills (I) consultancy |
| FIG. 30C | Increased innovation | More innovation |
| | input | management expertise (I) - |
| | Increased research and | consultancy |
| | market resources | More technical skills (R) |
| | | More market knowledge (M) |
| | | consultancy |
| FIG. 30D | Increased research input | More technical knowledge |
| | Increased market and | (R) |
| | innovation resources | More market knowledge (M) |
| | | consultancy |
| | | More entrepreneurial |
| | | skills (I) consultancy |

Another example of an application of the DSS, is where one of the 3 component vectors (R, I or M) is lacking. In this example innovation is used to exemplify the point. In the ideal situation (FIG. 30A) there is an optimum convergence of I, R & M to give sustainable innovation (R-I-M). In this embodiment (see FIG. 31A), where the innovation element I is substantially lacking, it is denoted in the correspondence graph as being a smaller I region 3100 that does not overlap with both R and M in a same region. As a consequence, there is no convergence area for R-I-M overlap. The options listed below in Table 2 are available to achieve convergence and sustainable innovation.

TABLE 2

| | Requirements for | | Functions available |
|---|---|---|---|
| | transformation to | | transform to ideal |
| Scenario | ideal scenario | | scenario |
| Innovation | a) | Increase market | Option e) would lead to |
| Scenario | | input in research | sustainable innovation |
| | b) | Increase research | Requirement: |
| | | input into market | More entrepreneurial |
| | c) | Increase market and | skills |
| | | research input | (I) Consultancy |
| | | simultaneously | |
| | d) | Increase innovation | |
| | | input into both | |
| | | research and market | |
| | e) | Increase innovation | |
| | | resource whiles keep | |
| | | market and research | |
| | | fixed | |

In this situation, the best option would be option e) because it would increase innovation resources to produce the ideal situation of FIG. 30A. Options a)-d) would lead to distortion of the key elements see below:

FIG. 31B is a correspondence graph of another embodiment of DSS that includes apply input (knowledge) and resource (human and financial) to affect the R-I-M overlap area. Achieving sustainable scalable innovation is achieved by the convergence of R, I and M to form R-I-M overlap space.

This can be achieved by (1) inputs being applied as denoted e.g. line 3107 which results in shifting M to the left or line 3105 which result in the shift of R to I in a north easterly direction, and (2) resources as denoted by the size/area (πr2) of the circle which is a function of the radius r (red line). Therefore the smaller the circle the smaller the resources either human and/or financial.

FIG. 31C presents another embodiment where the DSS can be combined with other innovation frameworks such as depicted below. In the example of FIG. 31C, showing an immature ecosystem, the DSS is combined with another human and financial resource frame work based on how research is supported by the public and the private sectors.

The transition from public to private sector results in the innovation, research and market entities increasing in size due to the increased resources both human and financial due to the maturity of the innovation ecosystem. Another direct result of this transition is the increase in entrepreneurship and research skill and capability within the ecosystem. FIG. 31D is similar to FIG. 31C, but is for the resultant of a mature ecosystem.

The DSS may also be helpful in guiding innovation and research efforts by considering the scale and impact of the research and innovation on different scales, such as micro, meso, and macro scales. Similarly DSS may be helpful in guiding the research and innovation to the marketplace by analyzing whether the research and innovation is driven my market push or market pull. By way of background, the present disclosure includes another level of analysis that points to the location, size, or scale of a research target. Three levels are described herein, although a finer granularity or broader (one or two level) granularity may be used as well: micro, meso (or middle) and macro (or large), each of which will now be discussed in turn.

The micro level is the smallest unit of analysis and generally relates to an individual such as a particular researcher, or a particular research project, or a small group such as projects related to a particular grant, proposal, or a faculty department at a university.

The meso-level draws from a larger population size and falls between the micro- and macro-levels, such as a college within a university, the university, a subsidiary of a company, or the company itself. In geographic terms it may also relate to a community, town/city, formal organization, province or state.

The macro-level tracts the impact on broader population segments such as at the national level (e.g., Saudi Arabia), regional area (e.g., Middle East and Northern Africa) or even global impact.

Conventionally, the micro, meso and macro analysis approach shows the micro, meso and macro regions as concentric, like that shown in FIG. 31E. However, by isolating the relationships between research, market and innovation for different levels (macro, meso, and micro), the DSS permits separate analysis of the alignment of research, innovation and market for different levels, or for hybrid areas (overlapping) as shown in FIG. 31F.

Another view of research as a market consumable is from a push/pull perspective. Push-supply is basically producing and then realizing demand and pull is realizing demand and then producing products. In the context of research, “push” refers to research that is performed with the goal of promoting the useful sciences in ways that might not be immediately realizable. On the other hand pull-demand in the research context is research performed with a specific goal in mind, namely to address a market need or a particular challenge that has been brought to the attention of the research. Similar notions of push/pull exist in the context of innovation and market realization. Research and innovation are similar in the context of push/pull theory in that research, like innovation, is in the push context attempts to anticipate what the market may need. Likewise, market driven research and innovation attempts to cure a deficiency that has been made apparent by the market.

Push/pull in the context of the market is different. The notion of “push” in the market context relates to providing new products to the public for which there is not yet a demand. Instead, a market needs to be created for the new product, which as a practical point could be a sizable hindrance to the successful launch of a business that manufactures that product because there is not yet a demand for the product and the cost of developing a market and identifying a customer base could be daunting challenges to successfully converting the selling the products or services in the marketplace. On the other hand, a pull-based market is one that has already identified a present need for particular products or services, and so the investment risk in supporting research and innovation for those products and services is lower because the demand for the products or services already exists.

Accordingly, the DSS may be applied at any one of the three levels: macro, meso, and micro to help align the research and innovation projects with a market that is categorized as a push or pull for that particular research or innovation project. In particular the KPI's used in vectors of FIGS. 3, 4 and 5 are elected to include attributes that are relevant to the level that is the subject of the analysis. For example, if information to help guide the decision is sought for the macro level, the attributes for the R vector of FIG. 3 would be adjusted such that peer review 303 would include all peer reviews internationally, grants available 307 would include all grants available internationally, etc. On the other hand, if the analysis was being performed on the meso level, these attributes would be restricted to a more restricted region such as MENA or Saudi Arabia. Likewise, an analysis performed at the micro level may be restricted to that that particular research institute or funding agency.

The same would be true for the market vector of FIG. 4 and the innovation vector of FIG. 5, where depending on whether the analysis is performed at the macro, meso, or micro level, the attributes of FIGS. 4 and 5 would be geographically restricted to the macro, meso or micro ranges. To further refine the market vector of FIG. 4 to support the macro, meso, and micro analysis, additional attributes may be included to more completely characterize the breadth of market reach for that particular market. For example, an additional attribute would be social media, where the number hits/tweets is monitored in certain regions for a particular product. Likewise, human participation in the form of attendance at seminars, webinars, etc. is used as a metric for level of interest in the particular product or service.

The composition of the M vector of FIG. 4 may be used to provide guidance on whether the market is supportive of a business model that is targeted for a push technology or a pull technology. For example, if the total sales 403 and $ for market product 407 have low values, this is indicative of a market push model. This information can be presented in the interface of FIG. 29 to indicate whether the market for the particular research or innovation is a push market or a pull market. The result may serve as an indication on whether further investment in the research or innovation is warranted in light of the likely business development costs needed to create a market where none (or not much of one) presently exists.

FIG. 32 is a flowchart of the process performed by the market gathering engine 113 (FIG. 1). The process begins in step 3201 where a possible target is identified and sent to the market gathering engine 113. The process proceeds to step S3203 where a query is made regarding whether the claims in the patents cover the target. If the response to the query in step S3203 is negative, the claims are amended in step S3205 and an index is incremented in step S3207. This increment is also made when the claims have already been determined to cover the target. The process then proceeds to step S3209 where a query is made regarding whether another target is identified. If the response to the query is negative the process proceeds to step S3209. However if the process is affirmative, a query is made in step S3211 regarding whether the claims cover the target product. If the response to the query in step S3211 is negative, the claims are amended in step S3213 and the index is incremented in step S3215. Likewise, the index is incremented in step S3215, when the response to the query in step S3211 is affirmative. The process then proceeds to step S3217, where a query is made regarding whether a Notice of Allowance was issued for a particular patent. If the response to the query in step S3217 is negative, the process proceeds to step S3211 while the prosecution continues and more targets are identified in the market database. However if the response to the query in step S3217 is affirmative, the process proceeds to step S3219, where a report of the value of X is made and a recommendation for a Continuation application to be filed is made.

The process then proceeds to step S3221, where a market value for the targets is identified. The process then proceeds to step S3223, where a query is made regarding whether there is a limit based on the region for the target products or the IP. If the response to the query in step S3223 is affirmative, the process proceeds to step S3225 where only those market items having a value for the region are included, and the process proceeds to step S3227, where the market value is reported. Likewise, the market value is reported if the response to the query in step S3223 is negative.

FIG. 33 is a flowchart describing the process performed by the research gathering engine 123 (FIG. 1). The process begins in step S3301, where a research project is identified for analysis. Then the process proceeds to step S3303, where a query is made regarding whether the publications exist that were peer reviewed and/or opened. If the response to the query in step S3303 is affirmative, the index is incremented by an index I, depending on the number of publications in step S3305 and the process proceeds to step S3307. In step S3307, a query is made regarding whether the number of grant proposals in a subject area is greater than a threshold Z. If the response to the query in step S3307 is affirmative, the process proceeds to step S3309 where the index is incremented by a factor Z and the process proceeds to step S3311. In step S3311, a query is made regarding whether the subject project has been granted one or more awards. If the response to the query in step S3311 is affirmative, the process proceeds to step S3313 where the index is incremented by a factor W, that is a function of the amount and number of awards. The process then proceeds to a query in step S3315, regarding whether the project has received an industry award. If the response to the query in step S3315 is affirmative, the process proceeds to step S3317, where the index is incremented by a factor Q and the process proceeds to step S3319.

In step S3319, a query is made regarding whether the researchers have an individual or accumulative ranking greater than a threshold R1. If the response to the query in step S3319 is affirmative, the index is incremented in step S3321 by a factor R1. The process then proceeds to a query in step S3323, where a query is made regarding whether a topic key term matches with the research grant term. If the response to the query is affirmative, the index is incremented in step S3325 by a factor T, and the process proceeds to a query in step S3327, inquiring whether a prototype was made. If the response to the query in step S3327 is affirmative, the index is incremented by a factor S in step S3329. The process then proceeds to another query in step S3331 regarding whether the research is a follow on to an earlier research project. If the response to the query in step S3331 is affirmative, the index is incremented by a factor N in step S3333. The process then proceeds to a query in S3335 regarding whether the research grant was greater than a predetermined threshold. If the response to the query in step S3335 is affirmative, the index is incremented in step S3337 by a factor of B. Subsequently the process proceeds to step S3339 where the research scorecard and scorer are produced and subsequently the process ends.

The methods and processes for the embodiments described above may be embodied in, and fully automated via, software code modules executed by one or more general-purpose computers, a server, an appliance, etc. The code modules for implementing the models described above may be stored in any type of computer-readable medium or other computer storage device and executed by one or more processors. Some or all of the methods may alternatively be embodied in specialized computer hardware. Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like.

The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed methods may be stored in any type of non-transitory computer data repository, such as databases, relational databases and flat file systems that use magnetic disk storage and/or solid state RAM. Some or all of the components shown in may also be implemented in a cloud computing system.

Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner.

Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The various elements, features and processes described herein may be used independently of one another, or may be combined in various ways. All possible combinations and sub combinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” and “an” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The foregoing disclosure, for purpose of explanation, has been described with reference to specific embodiments, applications, and use cases. However, the illustrative discussions herein are not intended to be exhaustive or to limit the inventions to the precise forms disclosed. Many modifications and variations are possible in view of the above teachings. The embodiments were chosen and described in order to explain the principles of the inventions and their practical applications, to thereby enable others skilled in the art to utilize the inventions and various embodiments with various modifications as are suited to the particular use contemplated.

The features and attributes of the specific embodiments disclosed above may be combined in different ways to form additional embodiments, all of which fall within the scope of the present disclosure. Although the present disclosure provides certain embodiments and applications, other embodiments that are apparent to those of ordinary skill in the art, including embodiments, which do not provide all of the features and advantages set forth herein, are also within the scope of this disclosure.

Each of the functions described in the embodiments may be implemented by one or more processing circuits (or circuitry). A processing circuit includes a programmed processor (for example, processor 1203 of FIG. 34), as a processor includes circuitry. A processing circuit also includes devices such as an application specific integrated circuit (ASIC) and conventional circuit components arranged to perform the recited functions.

Various components of the data system 100 and module computing device 200 described above can be implemented using a computer system or programmable logic. FIG. 34 illustrates a computer system 1201 upon which embodiments of the present disclosure may be implemented.

The computer system 1201 includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as the touch panel display 101 or a liquid crystal display (LCD), for displaying information to a computer user. The computer system includes input devices, such as a keyboard 1211 and a pointing device 1212, for interacting with a computer user and providing information to the processor 1203. The pointing device 1212, for example, may be a mouse, a trackball, a finger for a touch screen sensor, or a pointing stick for communicating direction information and command selections to the processor 1203 and for controlling cursor movement on the display 1210.

The computer system 1201 performs a portion or all of the processing steps of the present disclosure in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the present disclosure and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes.

Stored on any one or on a combination of computer readable media, the present disclosure includes software for controlling the computer system 1201, for driving a device or devices for implementing the invention, and for enabling the computer system 1201 to interact with a human user. Such software may include, but is not limited to, device drivers, operating systems, and applications software. Such computer readable media further includes the computer program product of the present disclosure for performing all or a portion (if processing is distributed) of the processing performed in implementing the invention.

The computer code devices of the present embodiments may be any interpretable or executable code mechanism, including but not limited to scripts, interpretable programs, dynamic link libraries (DLLs), Java classes, and complete executable programs. Moreover, parts of the processing of the present embodiments may be distributed for better performance, reliability, and/or cost.

The term “computer readable medium” as used herein refers to any non-transitory medium that participates in providing instructions to the processor 1203 for execution. A computer readable medium may take many forms, including but not limited to, non-volatile media or volatile media. Non-volatile media includes, for example, optical, magnetic disks, and magneto-optical disks, such as the hard disk 1207 or the removable media drive 1208. Volatile media includes dynamic memory, such as the main memory 1204. Transmission media, on the contrary, includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present disclosure remotely into a dynamic memory and send the instructions over a telephone line using a modem. A modem local to the computer system 1201 may receive the data on the telephone line and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an integrated services digital network (ISDN) card. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc.). The signals through the various networks and the signals on the network link 1214 and through the communication interface 1213, which carry the digital data to and from the computer system 1201 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

Obviously, numerous modifications and variations of the present invention are possible in light of the above teachings. It is therefore to be understood that within the scope of the appended claims, the invention may be practiced otherwise than as specifically described herein.

1. An information processing analysis system comprising:
data interface circuitry that
receives first data as an R vector regarding active research,
receives second data as an I vector regarding intellectual property including patents and patent applications, and
receives third data as a M vector regarding market-based information and actions; and
processing circuitry configured to
characterize the first data as a R region in a graphical R-I-M space,
characterize the second data as an I region in a graphical R-I-M space,
characterize the third data as a M region in a graphical R-I-M space, said processing circuitry comprising correlation circuitry that
correlates the respective R vector, I vector and M vector to determine respective overlap regions between respective of the R region, I region, and M region, wherein the processing circuitry is further configured to
compare at least one of a R-I region, I-M region, R-M region, and R-I-M region to a predetermined threshold, and based on a comparison result recommend one or more adjustments to at least one of the active research, the intellectual property, the market-based information and actions and/or priorities of the one or more adjustments to increase one or more respective areas of the R, I and M regions and/or one or more of the respective overlap regions.

2. The system of claim 1, further comprising a non-transitory computer readable storage medium that holds correlation coefficients for respective attributes of the R vector, the I vector and the M vector.

3. The system of claim 2, wherein the correlation coefficients are subdivided into groups, each group being specific to a query entered through the data interface circuitry.

4. The system of claim 2, wherein each attribute of each of the R vector, the I vector and the M vector have a weighting factor applied thereto that is associated with a query entered through the data interface circuitry.

5. The system of claim 2, wherein the attributes of at least one of the R vector, the I vector and the M vector are changed in accordance with an analysis query being received through the data interface circuitry for one of a macro level analysis, a meso level analysis, and a micro level analysis.

6. The system of claim 2, wherein the processing circuitry is configured to compare attributes of the M vector to a predetermined threshold so as to characterize the M vector as a pull market or a push market.

7. The system of claim 2, wherein the processing circuitry further includes a display controller that outputs information to a display that includes a graphical interface including an indication of an imbalance between the R region and the I region.

8. The system of claim 7, wherein the display controller outputs recommendation information to the display of a recommended change to the R vector and projected change in overlap regions as a consequence of adopting the recommended change.

9. The system of claim 2, wherein the processing circuitry further includes a display controller that outputs information to a display that includes a graphical interface including an indication of an imbalance between the R region and the M region.

10. The system of claim 9, wherein the display controller outputs recommendation information to the display of a recommended change to the R vector and projected change in overlap regions as a consequence of the recommended change.

11. The system of claim 2, wherein the processing circuitry further includes a display controller that outputs information to a display that includes a graphical interface including an indication of an imbalance between the M region and the I region.

12. The system of claim 11, wherein the display controller outputs recommendation information to the display of a recommended change to the I vector and projected change in overlap regions as a consequence of the recommended change.

13. An information processing analysis method comprising:
receiving via data interface circuitry first data as an R vector regarding active research;
receiving via the data interface circuitry second data as an I vector regarding intellectual property including patents and patent applications;
receiving via the data interface circuitry third data as a M vector regarding market-based information and actions;
characterizing with processing circuitry the first data as a R region in a graphical RI-M space;
characterizing with the processing circuitry the second data as an I region in a graphical R-I-M space,
characterizing with the processing circuitry the third data as a M region in a graphical R-I-M space;
correlating with correlation circuitry the respective R vector, I vector and M vector to determine respective overlap regions between respective of the R region, I region, and M region; and
comparing with the processing circuitry at least one of a R-I region, I-M region, R-M region, and R-I-M region to a predetermined threshold, and based on a comparison result recommending one or more adjustments to at least one of the active research, the intellectual property, the market-based information and actions and/or priorities of the one or more adjustments to increase one or more respective areas of the R, I and M regions and/or one or more of the respective overlap regions.

14. The method of claim 13, further comprising holding with a non-transitory computer readable storage medium correlation coefficients for respective attributes of the R vector, I vector and M vector.

15. The method of claim 14, wherein the correlation coefficients are subdivided into groups, each group being specific to a query entered through the data interface circuitry.

16. The method of claim 14, wherein each attribute of each of the R vector, the I vector and the M vector have a weighting factor applied thereto that is associated with a query entered through the data interface circuitry.

17. The method of claim 14, wherein the attributes of at least one of the R vector, the I vector and the M vector are changed in accordance with an analysis query being received through the data interface circuitry for one of a macro level analysis, a meso level analysis, and a micro level analysis.

18. The method of claim 14, wherein the processing circuitry is configured to compare attributes of the M vector to a predetermined threshold so as to characterize the M vector as a pull market or a push market.

19. The method of claim 14, wherein the processing circuitry further includes a display controller that outputs information to a display that includes a graphical interface including an indication of an imbalance between the R region and the I region.

20. A non-transitory computer storage medium having instruction stored therein that when executed processing circuitry perform an information processing analysis method, the method comprising:
receiving via data interface circuitry first data as an R vector regarding active research;
receiving via the data interface circuitry second data as an I vector regarding intellectual property including patents and patent applications;
receiving via the data interface circuitry third data as a M vector regarding market-based information and actions;
characterizing with the processing circuitry the first data as a R region in a graphical R-I-M space;
characterizing with the processing circuitry the second data as an I region in a graphical R-I-M space,
characterizing with the processing circuitry the third data as a M region in a graphical R-I-M space;
correlating with correlation circuitry the respective R vector, I vector and M vector to determine respective overlap regions between respective of the R region, I region, and M region; and
comparing with the processing circuitry at least one of a R-I region, I-M region, R-M region, and R-I-M region to a predetermined threshold, and based on a comparison result recommending one or more adjustments to at least one of the active research, the intellectual property, the market-based information and actions and/or priorities of the one or more adjustments to increase one or more respective areas of the R, I and M regions and/or one or more of the respective overlap regions.
